(19) United States
(12) Patent Application Publication
(10) Pub. No.: US 2011/0087966 A1
(43) Pub. Date: Apr. 14, 2011

(54) INTERNET CUSTOMIZATION SYSTEM

(76) Inventor: Yaniv Leviathan, Savyon (IL)

(21) Appl. No.: 12/577,974

(22) Filed: Oct. 13, 2009

(51) Int. Cl. G06F 3/048; G06F 15/16

(52) U.S. Cl. 715/745

(57) ABSTRACT

An apparatus for structuring web content including a structuring web server. The structuring web server includes a data collection server, a data analyzer, and a structured content server. The data collection server is configured to collect usage data associated with at least one user. The data analyzer is configured to generate improvement data based on the usage data. The structured content server is configured to send the improvement data to a browser associated with the at least one user. The browser uses the improvement data to alter a webpage displayed to the at least one user.

### BACKGROUND

The present disclosure relates generally to the field of digital content management and more particularly to website design.

Generally, when a website is built, its structure is determined right at the outset, at the site building time. However, during site building, information needed for making optimal website structure decisions is not necessarily available. Moreover, during the life of a website, the optimal website structure changes.

Often websites have a non-optimal navigational structure. For example, webpages which are frequently visited are located far away from each other, click-wise. This structure forces users to go through several irrelevant pages on their way from one frequent page to another. This has two negative consequences. First, the users have to wait for each page to load on the way to their destination in order to proceed, thus making their Internet surfing ineffective. Second, in such circumstances, users unfamiliar with the website find it hard to find their way throughout the site.

In addition, lists of links (such as news items) can contain too many irrelevant items thus hiding the relevant ones. Some links are “dead-links”, i.e. point to pages which no longer exist. When a website is built, the optimal design choices cannot be made since relevant information is lacking The website designer may not understand the content of the website since websites designers and content maintainers/creators are usually different people. Even if website design and content are done together, there may be many people creating the website who do not understand each other's content. Even if the website designers do understand the content, most of the content is usually not available during the design time, since content is regularly added to the site time and again.

Even if the content is all available to the website designers and even if the designers understand all of the content, the website designers usually do not understand the interconnections of the different parts of the content. If the website designers have all the content available and if they understand all of it as well as its interconnections, usually they still do not know what parts of the content are more relevant or interesting to the actual users of the site. Finally, even if the website designers have all the content available at design time, if they understand it all together with its interconnections and know the site audience perfectly and thus know exactly what pieces of the content most interest it and how to arrange them in a convenient manner, they still cannot usually succeed in creating the optimal site design. For a population A, design X is the optimal design, while for surfers of population B, design Y is optimal.

Thus, a need exists for improved systems and methods for managing website structure dynamically. Further, there is a need for improved systems and methods for automatically personalizing websites. Finally, a need exists for enabling an optimal website experience.

### SUMMARY

A representative embodiment relates to an apparatus for structuring web content including a structuring web server. The structuring web server includes a data collection server, a data analyzer, and a structured content server. The data collection server is configured to collect usage data associated with at least one user associated with an explicit profile. The data analyzer is configured to generate improvement data based on the usage data. The structured content server is configured to send the improvement data to a browser associated with the at least one user. The browser uses the improvement data to alter a webpage displayed to the at least one user.

Another representative embodiment relates to a system for structuring web content including a web server, a structuring web server, and a client. The web server is configured to serve webpages. The structuring web server configured to collect usage data associated with the webpages and generate improvement data based on the usage data. The client is configured to display webpages altered based on the improvement data and an explicit profile of a user.

Another representative embodiment relates to a method for structuring web content. At a computing device, data is collected from at least one client. The computing device builds an explicit profile of a user. The computing device analyzes the data from the at least one client. The computing device generates improvement data based on the analysis. The computing device generates information for modifying a webpage based on the improvement data and the explicit profile.

### BRIEF DESCRIPTION OF THE DRAWINGS

FIG. 1 is a diagram of an Internet customization system in accordance with a representative embodiment.

FIG. 2 is a diagram of an alternative Internet customization system in accordance with a representative embodiment.

FIG. 3 is a diagram of an architecture of an Internet customization system in accordance with a representative embodiment.

FIG. 4 is a diagram of a pre-installation Internet customization system in accordance with a representative embodiment.

FIG. 5 is a communication diagram of an Internet customization system in accordance with a representative embodiment.

FIG. 6 is a diagram of an architecture of a restructurer in accordance with a representative embodiment.

FIG. 7 is an illustration of an unmodified webpage in accordance with a representative embodiment.

FIG. 8 is an illustration of the webpage of FIG. 7 with link highlighting in accordance with a representative embodiment.

FIG. 9 is an illustration of the webpage of FIG. 8 with a second link highlighted in accordance with a representative embodiment.

FIG. 10 is an illustration of an unmodified webpage with content in accordance with a representative embodiment.

FIG. 11 is an illustration of the webpage of FIG. 10 with content highlighted in accordance with a representative embodiment.

FIG. 12 is an illustration of a webpage with a scroll suggestion in accordance with a representative embodiment.

FIG. 13 is an illustration of a second unmodified webpage in accordance with a representative embodiment.

FIG. 14 is an illustration of the webpage of FIG. 13 with a quick navigation bar in accordance with a representative embodiment.

FIG. 15 is an illustration of a webpage with a mixed quick navigation bar and immediate bar in accordance with a representative embodiment.

FIG. 16 is an illustration of a first link chain in accordance with a representative embodiment.

FIG. 17 is an illustration of a second link tree in accordance with a representative embodiment.

FIG. 18 is an illustration of an unmodified webpage with links in accordance with a representative embodiment.

FIG. 19, an illustration of the webpage of FIG. 18 with a fast forward button in accordance with a representative embodiment.

FIG. 20 is an illustration of the webpage of FIG. 19 with a fast forward menu in accordance with a representative embodiment.

FIG. 21 is an illustration of an unmodified webpage with items in accordance with a representative embodiment.

FIG. 22 is an illustration of a relevant webpage in accordance with a representative embodiment.

FIG. 23 is an illustration of the webpage of FIG. 22 with a minified page in accordance with a representative embodiment.

FIG. 24 is an illustration of the webpage of FIG. 14 with a control button in accordance with a representative embodiment.

FIG. 25 is an illustration of a webpage with link fix in accordance with a representative embodiment.

FIG. 26 is an illustration of a third link chain in accordance with a representative embodiment.

### DETAILED DESCRIPTION

A method, system, and apparatus for an Internet customization system and method are described. In the following description, for purposes of explanation, numerous specific details are set forth to provide a thorough understanding of representative embodiments of the invention. It will be evident, however, to one skilled in the art that the invention may be practiced without these specific details. Well-known structures and devices are shown in simplified form to facilitate description of the representative embodiments.

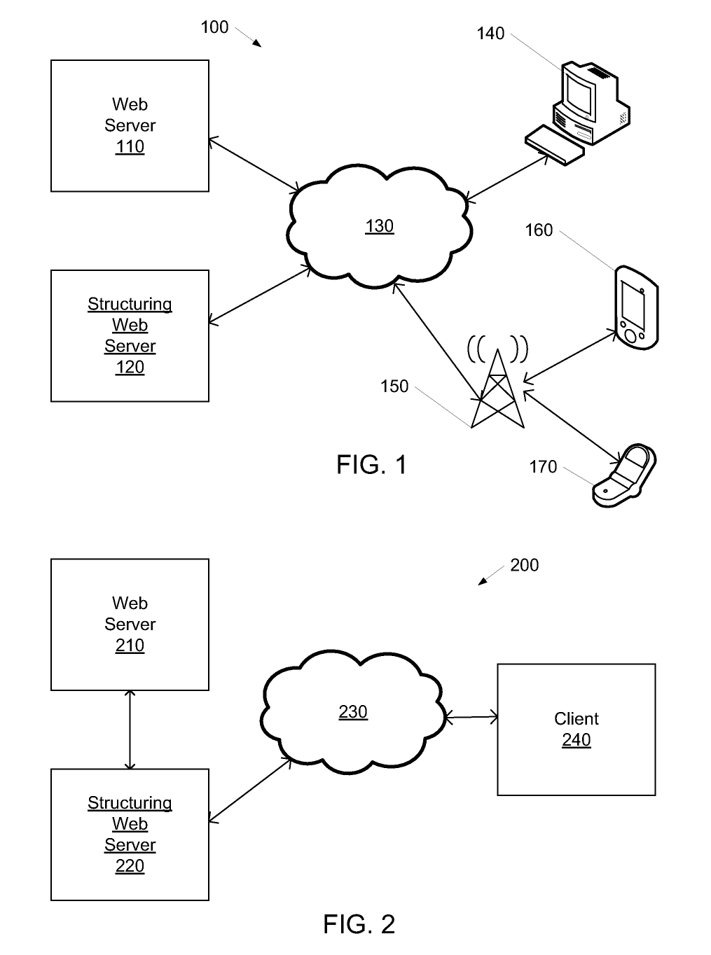

Referring to FIG. 1, a diagram of an Internet customization system 100 in accordance with a representative embodiment is shown. The Internet customization system 100 includes a web server 110, a structuring web server 120, a network 130, a client 140, a wireless network 150, a personal digital assistant 160, and a cell phone 170. The server 110, the structuring web server 120, the client 140 and the wireless network 150 are connected to the network 130. The personal digital assistant 160 and the cell phone 170 are connected to the network 130 through with the wireless network 150. The network 130 can be, for example, the Internet, an intranet, a SONET, or any other network. The server 110 can be a computer including a processor, memory, disk drives, a display, a keyboard, and input devices. The client 140 can be a computer, such as a personal computer or laptop, configured to display webpages of a website. The client 140 can include a processor, memory, disk drives, a display, a keyboard, and input devices. The server 110 stores and serves web pages associated with one or more websites, for example, Hypertext Markup Language (HTML) files and associated data files, to devices that request a webpage. For example, the client 140 can request a webpage from the server 110, and the server 110 can send the webpage files to the client 140. A user can view webpages and navigate a website using the client 140. The client 140 can also be configured to alter files associated with a webpage and send information back to the server 110. The personal digital assistant 160 and the cell phone 170 can also request and display webpages as well as send information.

The structuring web server 120 can include a processor, memory, disk drives, a display, a keyboard, and input devices. The structuring web server 120 can be configured to alter files associated with a webpage, for example, Hypertext Markup Language (HTML) files and associated data files. The structuring web server 120 can also store and serve web pages associated with one or more websites. The structuring web server 120 can communicate with the web server 110, the network 130, the client 140, the wireless network 150, the personal digital assistant 160, and the cell phone 170. For example, the client 140 can request a webpage from the server 110, and the server 110 can send the webpage files and a reference to a script to the client 140. The reference to the script instructs the client 140 to contact the structuring web server 120 which provides the client 140 with further data and instructions. The structuring web server 120 and the server 110 can be located at different facilities. Alternatively, the structuring web server 120 and the server 110 can be the same computer or be connected with a dedicated link. The structuring web server 120 can also be connected to external databases and other structuring web servers.

Referring now to FIG. 2, a diagram of an alternative Internet customization system 200 in accordance with a representative embodiment is shown. The Internet customization system 200 includes a web server 210, a structuring web server 220, a network 230 and a client 240. The structuring web server 220 and the client 240 are connected to the network 230. The web server 210 is connected to the structuring web server 220. When the client 240 requests a webpage from the web server 210, the structuring web server 220 receives the request and forwards the request to the web server 210. For example, the structuring web server 220 is connected between the web server 210 and the network 230 and is configured to forward packets back and forth between them, altering the transmitted files on their way. Alternatively, when the client 240 queries its domain name server (DNS) for the address of the web server 210, and the DNS sends the address of the structuring web server 220 to the client 240. The web server 210 can send the webpage files to the client 240 through the structuring web server 220. The structuring web server 220 can alter files associated with a webpage, for example, Hypertext Markup Language (HTML) files and associated data files before forwarding the files to the client 240. The client 240 can also be configured to alter files associated with a webpage and send information back to the structuring web server 220.

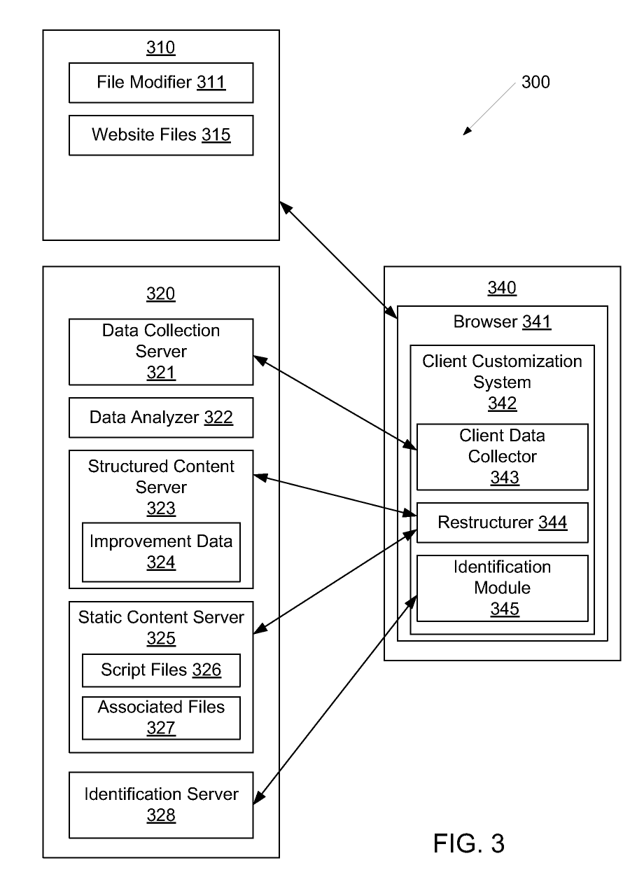

Referring now to FIG. 3, a diagram of an architecture of an Internet customization system 300 in accordance with a representative embodiment is shown. The Internet customization system 300 includes a web server 310, a structuring web server 320 and a client 340. The web server 310, the structuring web server 320 and the client 340 each have components that work together to optimize one or more websites.

The web server 310 can be a typical web server used for serving webpages of a website to a client. The web server 310 includes website files 315 that are associated with webpages. Website files 315 include, for example, HTML files, images, scripts, multimedia, etc. The website files 315 can be stored in any format or language such as HTML, PHP, Flash, etc. A browser interprets and/or executes the website files 315 in order to display a webpage and its content to a user.

The web server 310 of the Internet customization system 300 can be configured in a variety of different ways. In a representative example, a line of code referencing a script file is added to at least one of the website files 315, for example, a HTML file. When a browser in a client interprets the line of code, the script will be executed. Alternatively, if the website files 315 are dynamically generated using a template, a reference to the script file can be added to the template. A file modifier 311 can add the reference automatically to the website files 315. A server plug-in can add the reference on the fly, when the website files 315 are served. Additionally, references can be added to each file manually.

The client 340 includes a browser 341. The browser 341 can be any web browser, for example, Mozilla Firefox available from the Mozilla Foundation, Mountain View, Calif.; Internet Explorer available from the Microsoft Corporation, Redmond, Wash.; or Chrome available from Google Corporation, Mountain View, Calif. The browser 341 can be used to interpret and executed website files 315, for instance, to display a webpage. The browser 341 includes a client customization system 342 which can be a plug in or add-on to the browser 341. Alternatively, the client customization system 342 can be an extension of the browser 341, a script, or a separate program. The client customization system 342 can also be integrated directly into the browser 341. The browser 341 and the client customization system 342 operate together to display a webpage associated with the website files 315. When the browser 341 accesses one of the website files 315 (where at least one of the files includes a reference to a script) the browser 341 downloads and runs the client customization system 342 from the structuring web server 320. Alternatively, the client customization system 342 can be pre-installed or be included with the browser 341.

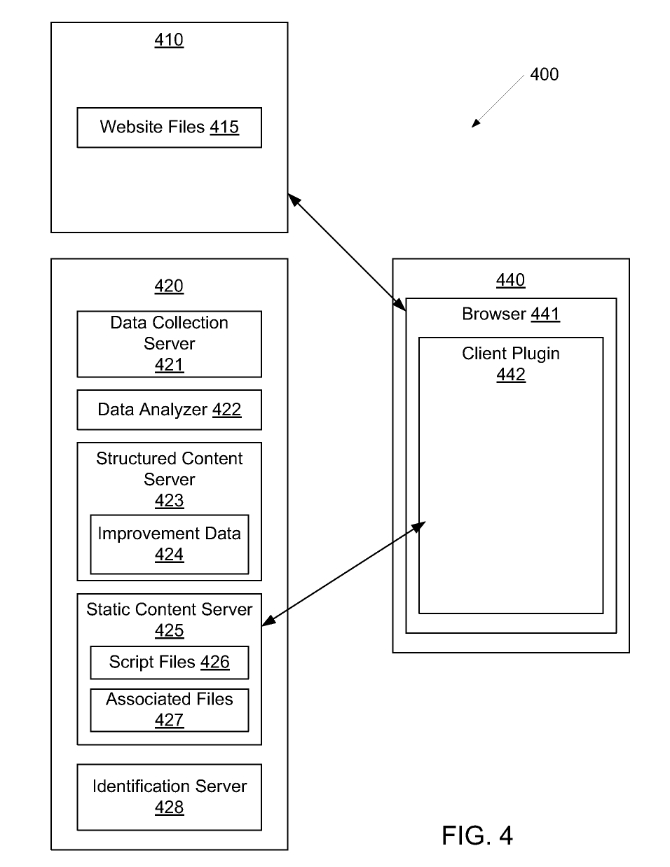

Referring now to FIG. 4, a diagram of a pre-installation Internet customization system 400 in accordance with a representative embodiment is shown. Web server 410 includes website files 415. When a user associated with client 440 accesses website files 415, the user is prompted to install a client plugin 442. Alternatively, the user has already installed the plugin. At the client 440, the plugin associated with browser 441 can download and install a client customization system from a static content server 425 of a structuring web server 420 as if a reference to a script were included in the visited page. The client customization system can be installed using script files 426 and associated files 427. Alternatively, the client customization can be included in the plugin itself. The structuring web server 420 also includes a data collection server 421, a data analyzer 422, a structured content server 423, and an identification server 428. The structured content server 423 generates and maintains improvement data 424.

Referring again to FIG. 3, the client customization system 342 includes a client data collector 343, a restructurer 344, and an identification module 345. The restructurer 344 can modify website files 315 such as HTML files. For example, the file restructurer 344 can alter an HTML file to delete, replace, or add a hypertext link. The client data collector 343 collects data related to browser usage. For example, the client data collector 343 can record which uniform resource locator (URL) is visited, the referring URL, the webpage title, the webpage visit duration, what hypertext links a user activates (i.e. clicks), and the text the user enters while filling out web forms. The client data collector 343 can store information in some local storage facility, such as cookies or user files. The restructurer 344 can also request improvement data from structuring web server 320 which restructurer 344 can use to alter the webpage. For example, the improvement data can be used to highlight links on a webpage or to generate a list of quick navigation bar links as described further below.

The client data collector 343 can send the information to the structuring web server 320, for example, the client data collector 343 can send a message to the structuring web server 320 at the time of a click or before leaving a webpage. Alternatively, the structuring web server 320 can infer webpages the user visits, for example, a message is sent only upon reaching a webpage and the link clicked on the previous page is inferred from the referrer.

The identification module 345 creates and maintains profiles of users associated with the client 340. When the client 340 accesses a website, the identification module 345 identifies the particular user associated with the client 340 (this is done mutually with the structuring web server 220 as described further below). The functionality of the identification module 345 can be shared with the structuring web server 320. The identification module 345 creates and maintains an explicit profile for each user. The identification module 345 allows the user to answer questions about himself, thereby allowing the Internet customization system 300 to understand his profile and generate appropriate improvement data. The identification module 345 includes a profile builder, a profile editor and a distributed profile builder which creates and maintains user profiles.

For every website or website type, the profile builder of the identification module 345 has a list of relevant questions. For example, for a university site, the list can be: “Are you a student, a professor, a candidate, etc.” or, in case the user is a student: “Are you a mathematics student, an art student, a history student, etc.” The questions in the list, as well as their order can be either explicitly set by a website webmaster, or by the Internet customization system 300 itself, based on the answers of other users in other websites. For example, the order of the questions can depend on prior answers, for instance, what subject one studies should only be asked after other questions such as whether one is a student. As a user surfs webpages, the identification module 345 can display a question based on the user's activity. The user's answer is incorporated into the user's profile.

A user can also access a profile editor associated with the identification module 345. While surfing a website associated with the Internet customization system 300, the user can open a control panel were he is presented with all the questions that are relevant to that website, where he can answer them easily. The user can also change previous answers. A user can also access the profile editor by visiting a user webpage accessed through the structuring web server 320, where he can edit his profile easily.

The distributed profile builder of the identification module 345 can build the user profile in a distributed fashion. While a user profile can consist of a large variety of attributes, the user does not necessarily have to explicitly provide profile information immediately. Instead, when the identification module 345 detects that a certain user would benefit from answering a certain question (this means that the system determines that there is a significant chance of the user answering the question as well as the site experience improving after the question is answered) it presents the question to him in a simple, easy-to-answer fashion, such as a pop-up window.

For example, in a university website it might be very helpful to know if a certain user is a student and, if so, what he studies. Suppose that a user has told the system that he is a student. Also suppose that the user is a mathematics student; however, the user has not provided this information. When the user performs a mathematics-student-like behavior (for example, accessing the home page of the mathematics department) the system will pop-up a small window with the contents: “Are you a mathematics student? Yes/No/Close”. If the user answers the question, the site's navigational features will immediately change to better suit him. This answer, as long as the user hasn't changed it, will be carried along with him to other sites, improving the content there as well.

The Internet customization system 300 is designed around a profile ownership model where the user is the sole owner of his or her user profile data. Only data explicitly entered by the user, or explicitly allowed by the user is associated with him. Unlike other systems which cannot rely on the user to supply information about himself, as the user has no incentive to do so, the Internet customization system 300 enables this reliance on user cooperation by providing the user a strong and immediate positive feedback for supplying the information—namely improving the site's navigation. The user has full control of the data. This means that the user can see all of the data associated with him and change all of the data associated with him at any given time. Changing, includes deleting, so the user can delete all or part of his data (thereby completely disassociating the data from the user). The user can see and, to some extent, control which parties receive access and to the data and control which parts of the data can be accessed.

Unlike other recommendation systems, the Internet customization system 300 can be based on explicit profiles. Using implicit profiles might seem as an advantage, as it does not require user participation and the user is not encumbered with long forms. Encumbering the user with long forms is onerous; however, the identification module 345 can gradually build explicit profiles without encumbering the user at all. As far as user participation goes, although a user might not cooperate in order to improve ads or product recommendations, if the user is presented with an immediate beneficial feedback consisting of improving his surfing experience, and if the input required by him is easy and fast, he would gladly participate, and even prefer to manually control his recommendations, rather than having a system that tries to predict who he is.

There are many advantages to an explicit profile approach. Explicit profiles are much more accurate than purely implicit profiles. Explicit profiles can be understood by humans. This enables meaningful analytics for the first time. This also enables the profile ownership model as discussed above. Explicit profiles can be initialized and changed easily. For instance, in an implicitly generated profile, the user is interested in subject X for a few months, but then stops being interested in X and starts being interested in Y instead (for example, a student at a university changes his major). The user will have to wait until the system learns that he is really interested in Y, and in the meantime the user will receive inappropriate recommendations. In another example, a new user is interested in subject Z. He will have to wait until the system understands this fact, in the meantime he receives bad recommendations. Such a behavior is unacceptable if the goal is to provide the user with a reliable structuring mechanism as a main navigation facility.

Explicit profiles can also support many users on the same computer. An implicit profile cannot discern between users. Explicit profiles can also support temporary profiles and long term profiles.

Explicit profiles can also be shared across sites. Explicit profiles enable a unique business model. This feature also allows a user to have appropriate recommendations starting from the first visit of a given site. Explicit profiles enable non-encumbering profile building approach (see Distributed Profile Building above), which solves the user encumbering problem.

Explicit profiles can enable transferring user profile data between sites without needing the user to login at each site. This eliminates the burden existing in other cross-site systems. It also adds to the user's feeling of anonymity—the data stored at the structuring web server 220 can be disassociated from users. The user's data is associated to the user on the user's computer. In cases in which the user wishes to synchronize his profile across computers or browsers, he can create a username and password, but this username does not need to be associated with the real user in any way (the user can create an alter-ego). Even if the user chooses to use the username/password approach, he only needs to login once for all sites (i.e. single sign on). In addition, the profile items can be non-sensitive, possibly vague statements, such as “I am a student” or “I am between 10 and 20 years old” furthering the user's confidence in the Internet customization system 300.

The structuring web server 320 includes a data collection server 321, a data analyzer 322, a structured content server 323, a static content server 325, and an identification server 328. The data analyzer 322 generates and maintains improvement data 324, served by the structured content server 323. The structured content server 323 sends the improvement data 324 to the restructurer 344. The static content server 325 serves the static content for the configuration in case the configuration is initiated by the web server 310. The static content server 325 includes script files 326 and associated files 327.

When a client is accessing a website, the user is identified mutually by the client identification module 345 and the identification server 328. This identification supports the explicit profile approach as discussed above. Based on the user's identification, the restructurer 344 then receives the appropriate improvement data files of improvement data 324 and applies them to the webpages of the site. Alternatively, the restructurer 344 can be located at the structuring web server 320.

The data collection server 321 collects statistic usage data from the client data collector 343 including data related to browser usage, for example, data related to what hypertext links a user activates (i.e. clicks), what webpages the user visits, where a user spends the most time during a viewing of a website, and the text the user enters while filling out web forms. The data collection server 321 can collect information from many different users and many different clients. The data collection server 321 stores the collected data for analysis by the data analyzer 322. The data analyzer 322 analyzes the usage data and infers which pages are of interest to the users, for instance, which content should be highlighted. The data analyzer 322 creates improvement data 324.

The data analyzer 322 can use various algorithms to determine what information should be included in the improvement data 324. In a representative improvement data algorithm, improvement data for a quick navigation bar is generated. Let M be the number of unique profiles. Let R1, . . . , RM denote profiles 1 through M. Let N denote the number of pages of the site. Let S1, . . . SN denote pages 1 through N of the site. Let k denote the number of links. Let Pi,j denote the amount of user interest in page Sj given he has profile Ri. This amount can be estimated with a variety of methods and heuristics, such as relying on implicit parameters like the time users spend on the page, their interactions with the page or cases where the users clicked on back very fast, or explicit parameters, like thumbs up/thumbs down. For this example, we will set Pi,j=Prob(User visits page Sj|User has profile Ri). The estimator of user interest in a page is simply his probability of visiting the page. For each profile Ri, the links are calculated as follows: For each j, calculate Pi,j. Sort the Pi,j's and select the k largest ones: Pi,j1, . . . ,Pi,jk. The improvement data consists of links to pages Sj1, . . . ,Sjk.

In another representative improvement data algorithm, improvement data for a quick navigation bar is generated. Using the notations of example 1 above calculate the links as follows: For each j, calculate Pi,j. For each 2 pages Sn and Sm of the site, let d(Sn,Sm) be the minimum number of clicks needed to get from page Sn to page Sm. If there is no link path from Sn to Sm, let d(Sn,Sm)=Z. For each subset V of size k of the pages of the site, and for each page S1, let d(V,S1)=min(d(Sn,S1)|Sn is in V). For each such subset V of size k, calculate Score(V)=Σ_{j=1, . . .,N}((d(V,Sj)̂X)*Pi,j). The improvement data consists of links to the pages of the set V, such that Score(V) is minimal. For example, if X=1, this algorithm minimizes the expected number of clicks the user with profile Ri will perform on the way to his target page.

In another representative improvement data algorithm, improvement data for a link highlighter is generated. Using the notations from above, let t be a parameter of the algorithm. Let Sk,j,i denote the quality of link Lk for users with profile Ri on page Sj. As an example, we will use the probability of a user with profile Ri clicking on link Lk on page Sj as the quality measure, Sk,i,j. To calculate the link highlights in page Sj, for a user with profile Ri: For each link Lk in page Sj, calculate Sk,j,i=Prob(the user will click on link Lk|the user is on page Sj and has profile Ri). For each link Lk in page Sj, highlight Lk if Sk,j,i>t.

In another representative improvement data algorithm, improvement data for a link highlighter is generated. On each page Sj, divide the set of links on the page to sets of associated link lists. For example, if the page consists of a main navigation bar links, a secondary navigation bar links and a list of news item links, each of these three components' links constitutes such an associated link list. Then apply the previous algorithm to each individual associated link list.

The increase in the quality (in the above example, probability) of the link due to the user's profile can be used to determine its chance of being highlighted, rather than the absolute quality. For example, setting Sk,j,i=Prob (the user will click on link Lk|the user is on page Sj and has profile Ri)/Prob(the user will click on link Lk|the user is on page Sj) instead of as above.

In another representative improvement data algorithm, improvement data for a fast forward is generated. Using the notations above, for each link Lk in page Sj and user profile Ri, a list of links Vi,j,k=Vi,k,j,1, . . . ,Vi,j,k,m to be displayed are calculated as fast forwards for link Lk on page Sj for user Ri. Let Pi,j,k,n denote the amount the user with profile Ri that clicked on link Lk on page Sj is interested in page Sn. In order to calculate this user's interest level in a page a variety of methods can be employed. For example, similar to the examples above, Pi,j,k,n can be set to be the probability of a user with profile Ri's session ending in page Sn given that he clicked on link Lk on page Sj. A user session is said to be ending in page Sn, if the last page on the site the user browsed to on the given session was Sn. Other criterions such as the user session's destination (as opposed to ending) can be used where a session's destination is the page the user intended to reach in the session, not necessarily the last page reached. Calculate Pi,j,k,n. If Pi,j,k,n>t, add page Sn to Vi,j,k (where t is a parameter of the algorithm). If length(Vi,j,k)>0 add a FF icon next to link Lk on page Sj for users with profile Ri, containing the link in Vi,j,k. Another variation is adding the fast forward only if Pi,j,k,n>t and if Prob(user will click on link Lk|user has profile Ri and is on page Sj)>T (where t and T are parameters of the algorithm).

In another representative improvement data algorithm, improvement data for a fast forward is generated. As an example extension to the algorithm above, consider the following. Let h, a monotonic increasing function from the integers to the integers, be parameter of the algorithm. Calculate Pi,j,k,n like above. For each 2 pages Sn and Sm of the site, let d(Sn,Sm)=minimum number of clicks needed to get from page Sn to page Sm. If there is no link path from Sn to Sm, let d(Sn,Sm)=Z. For each subset V of the pages of the site, and for each page S1, let d(V,S1)=min(d(Sn,S1)|Sn is in V). For each such subset V calculate Score(V)=h(size of V)+Σ_{n=1, . . . ,N} ((d(V,Sn)̂X)*Pi,j,k,n). Choose Vi,j,k such that Score(Vi,j,k) is minimal. Add a FF for link Lk with contents Vi,j,k if Score(Vi,j,k)<t and number of elements of Vi,j,k>0. Several obvious precautions need to be taken, such as not adding a fast forward to the page the link is directly linking to, or to the source page, as such a fast forwards would be redundant.

Standard techniques can be applied to remedy situations in which the calculations are inaccurate. For example, if very few users with profile R visited page S, some of the traits of profile R can be ignored. A broader profile R′ of which R is a special case can be considered.

Improvement data files sent to a client can be cached, in order to eliminate the need to re-download them from a structuring web server each time. The caching can rely on a mechanism such as hashing (e.g. etags). Alternatively, caching can be for a limited time, so as to not prevent updates from getting to the user.

In addition to caching, all of the improvement data files for the different components can be grouped together to a single file, so as to reduce the number of file requests by a client from a structuring web server. On the other hand, the improvement data of a quick navigation bar (described further below) for example, being more static, can be in a file of its own in order to enable caching for longer periods.

Finally, the structuring web server can send the data for the most frequent pages of the website (for the given user) in a single file, instead of in multiple files. A client can then request this file first. As this file will always be requested first, it will likely be cached. Only if the current webpage is not among the most popular pages of a website, a second request will be made by the client. This can save the requests for the most frequent pages altogether. This scheme can be extended as needed to allow for several nested cache layers.

The process of a client sending usage statistics and the structuring web server collecting it can be completely disabled. Instead, the system can be instructed to function from manual data, for example, data entered by the webmaster of a web server. Thus, the task of identifying an optimal structure of the site is left at the hands of a human, but the task of enforcing this updated and optimal design is still carried out automatically by the structuring web server.

The website's structure can be maintained by a human, without him having to modify any website pages. The task of deciding the optimal structure can be divided between the structuring web server and a human manager. For example, the structuring web server can work fully automatically, but allow the webmaster of the web server to manually promote selected content or links. In addition, the task of deciding the optimal structure of the site can be left at the hands of the user/surfer, supplying him with a mechanism to perform this task.

The profile concept discussed above enables special business models. For example, the following two-tiered business model. Tier one consists of tailoring a site for free (for both the users and the site owners) and in return, collecting explicit profile traits of the users that are relevant to the site. Tier two consists of employing this information to tailor ads or product recommendations. This business model allows tailoring and benefiting from the tailoring of all sites, even non-profit sites like universities or blogs.

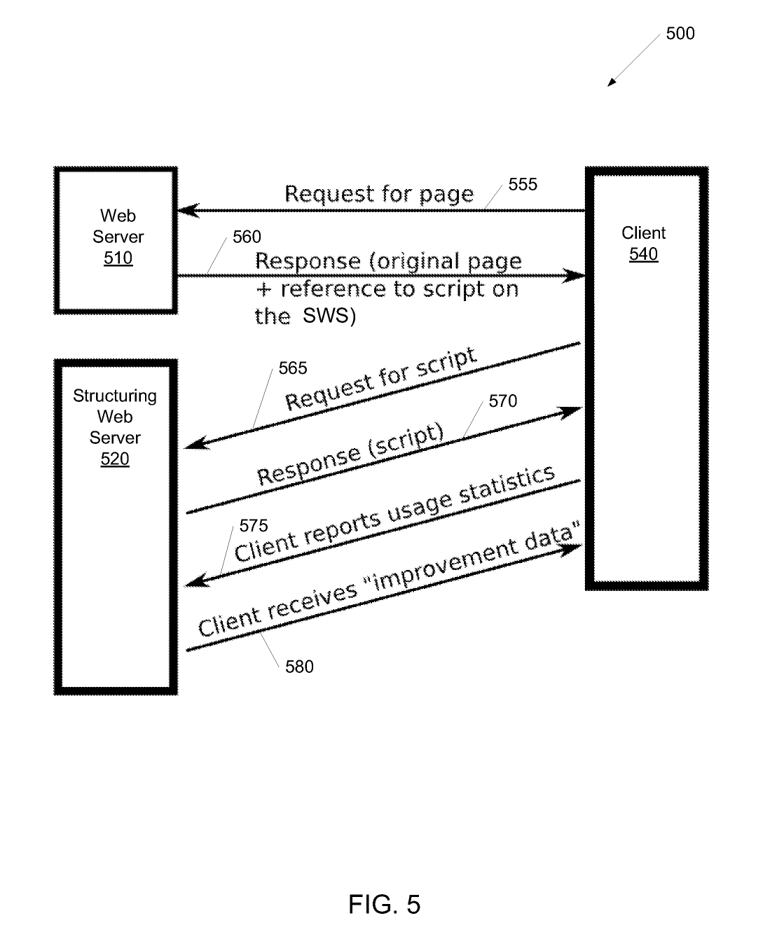

Referring now to FIG. 5, a communication diagram of an Internet customization system 500 in accordance with a representative embodiment is shown. The Internet customization system 500 includes a web server 510, a structuring web server 520, and a client 540. Operations 555-580 are representative operations performed in the Internet customization system 500. Additional, fewer, or different operations may be performed depending on the implementation.

In operation 555, the client 540 requests a webpage from web server 510. In operation 560, the web server 510 returns a web page and a reference to a script in the structuring web server 520 to the client 540. In operation 565, the client 540 requests the referenced script from the structuring web server 520. In operation 570, the structuring web server 520 returns a response script to the client 540. The client 540 runs the response script. The script, for example, instructs a browser running on the client 540 to alter the web page as described further below. In operation 575, the client 540 reports usage statistics to the structuring web server 520. For example, usage statistics can include information collected regarding a particular user such as frequently visited pages, time spent on pages, order of page accesses and buttons pressed. In operation 580, the structuring web server 520 returns improvement data to the client 540. For example, improvement data can be used with the script to alter the web page as described further below.

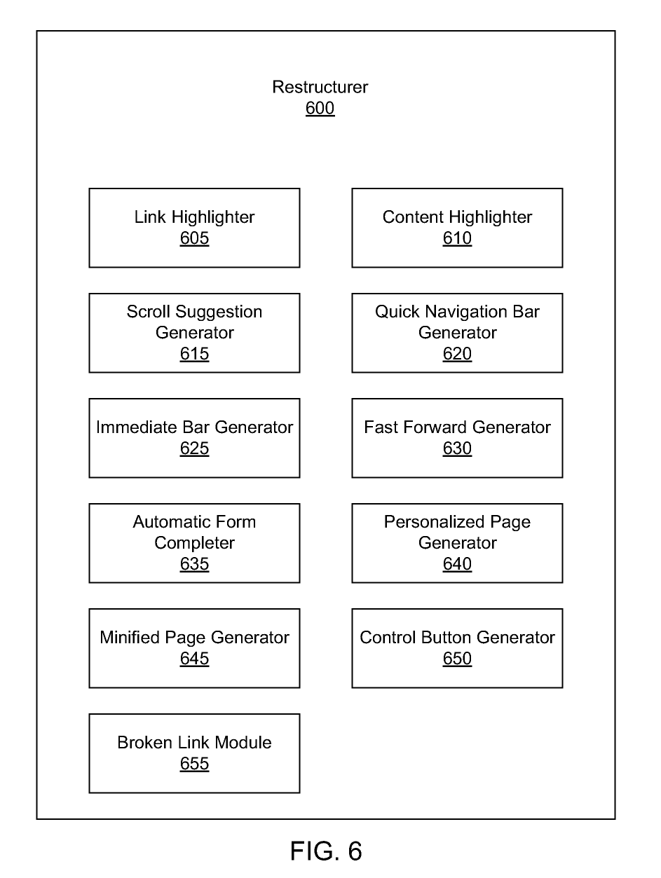

Referring now to FIG. 6, a diagram of an architecture of a restructurer 600 in accordance with a representative embodiment is shown. The restructurer 600 includes a link highlighter 605, a content highlighter 610, a scroll suggestion generator 615, a quick navigation bar generator 620, an immediate bar generator 625, a fast forward generator 630, an automatic form completer 635, a personalized page generator 640, a minified page generator 645, a control button generator 650, and a broken link module 655. Generally, the restructurer 600 creates instructions for deleting, replacing, and/or adding at least one piece of new HTML code to an existing HTML file. For example, the restructurer 600 can creates instructions for inserting a new link in the HTML code of a webpage. The restructurer 600 can also create instructions for associating a file with the new HTML code. For example, the new HTML code can cause the webpage to display a new graphic. The restructurer 600 can also create instructions for rearranging a webpage or creating an entirely new webpage. Alternatively, the restructurer 600 can provide or complete elements of a Document Object Model (DOM).

The link highlighter 605 highlights links identified by improvement data. If the usage data suggests that it is very likely that the user will click on a certain link, or that a certain link might be of interest to him, the data analyzer generates improvement data that instruct the link highlighter 605 to highlight the link on the relevant webpage. For instance, the link highlighter 605 can insert the HTML code “<font style=”background-color: yellow;“>” and “</font>” around the link to be highlighted in the respective webpage's HTML file. The link highlighter 605 can also add a small icon next to the link or change the background color or image of the link in order to differentiate it from other links. This change can be static, or activated by some user action, such as clicking a “highlight-links” button on a toolbar, or hovering with a mouse cursor over a certain area of the webpage. The link highlighter 605 can also create an animated change. Icons or backgrounds can vary according to the nature of the highlight. Thus, a highlight can depend on the probability of clicking the link or on the reason the link is highly probable. For example, for a link that other users have clicked frequently, the link highlighter 605 can apply a red (hot) highlight. For a link that other users have clicked infrequently, the link highlighter 605 can apply a blue (cold) highlight. Links which have low overall probability amongst other users but have a higher than the average probability for the specific user can also be highlighted.

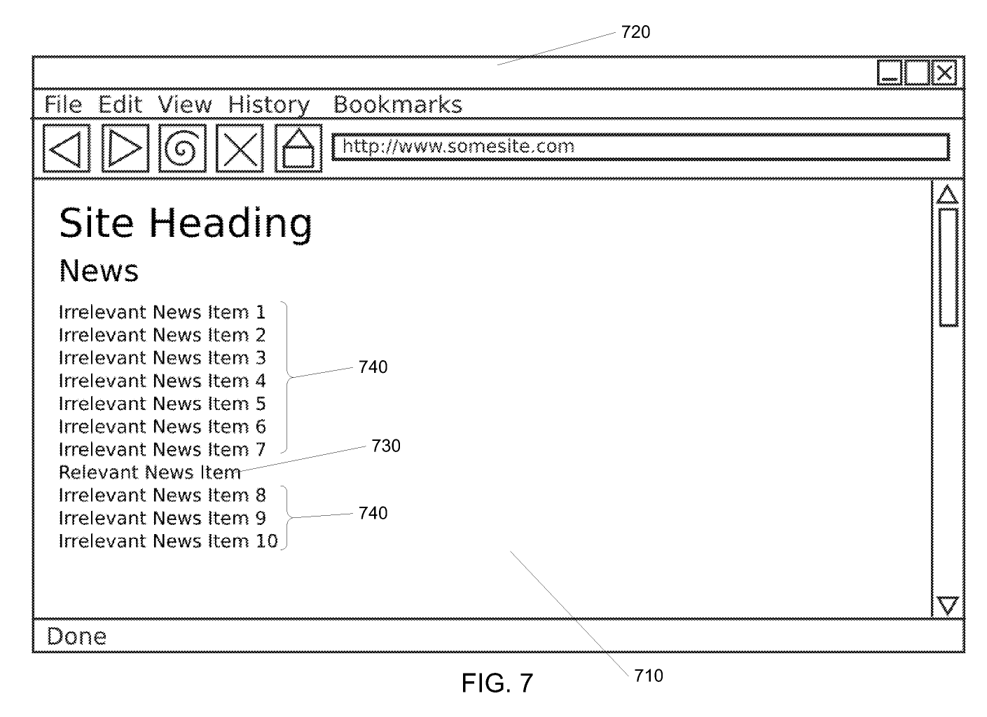

Referring now to FIG. 7, an illustration of an unmodified webpage in accordance with a representative embodiment is shown. The webpage 710 is displayed in browser 720. The webpage 710 includes irrelevant links 740 and relevant link 730. Relevant link 730 does not stand-out on the webpage 710 and, therefore, is difficult for a user to quickly identify the relevant link 730.

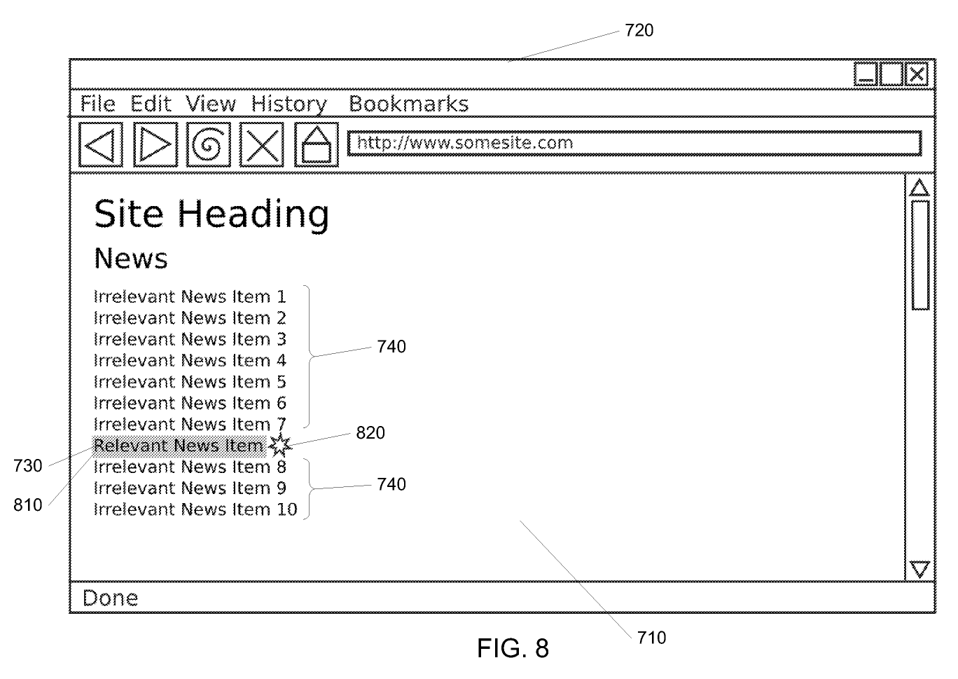

Referring now to FIG. 8, an illustration of the webpage of FIG. 7 with link highlighting in accordance with a representative embodiment is shown. The Internet customization system collects and aggregates the statistics for the click frequency of all links. The Internet customization system then determines the interest level of each link. The interest level of each link can be determined for instance by the click frequency of the link. The calculation of the interest level of the link can depend on the user's profile. Thus, links with high click frequency are determined to be of interest to the users. If, for example, upon reaching a page, a certain link has a probability of being clicked greater than a threshold, then the certain link is considered to be interesting. Other factors, such as the number of links in the page, the size of the link, etc. can also be taken into account when determining the link's level of interest.

In a representative example, the improvement data of the Internet customization system indicates that the relevant link 730 is of most interest to the user based on other users' with similar profiles link choices. After executing the link highlighter, the webpage 710 is displayed in browser 720. The webpage 710 includes irrelevant links 740 and relevant link 730. Now, relevant link 730 is highlighted with highlighting 810. In addition, the link highlighter has placed an icon 820 next to the relevant link 730 (e.g. by modifying the DOM). The link highlighter can also change the colors of the relevant link 730. Advantageously, the user can now easily identify the relevant link 730. A webmaster can also configure the system to use a highlighted version of the links which is prepared in advance so, for example, if the links are images, the webmaster creates a highlighted version of the images and the script replaces the relevant images with their highlighted version. When the system detects that a link is new in the page, it can also highlight it with a special “new link” icon. Also, when the link highlighter is applied to a page containing search results, the most appropriate search results for the user's profile and keywords are highlighted, thus substantially improving the search.

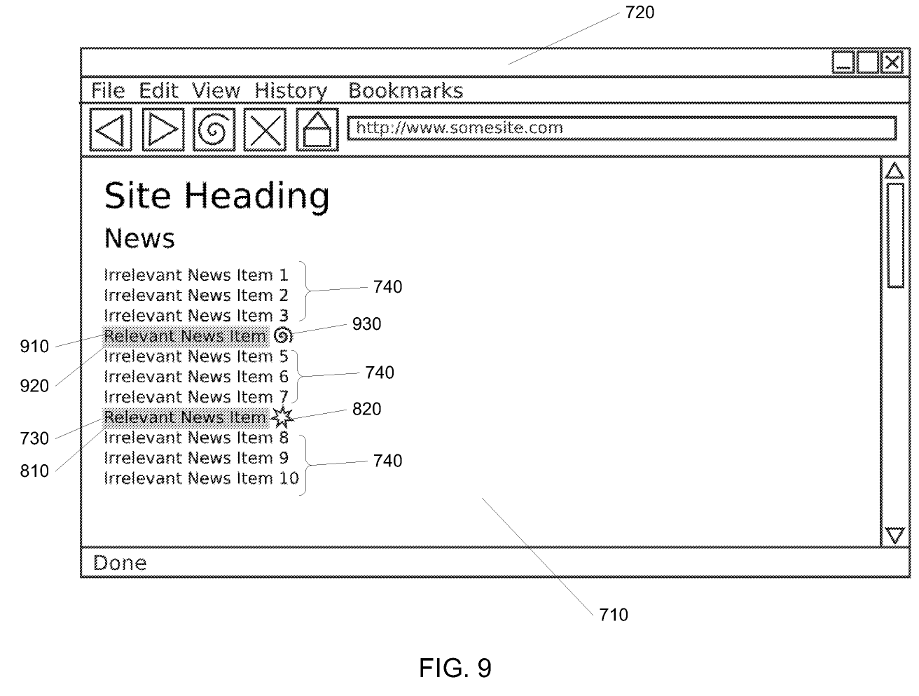

Referring now to FIG. 9, an illustration of the webpage of FIG. 8 with a second link highlighted in accordance with a representative embodiment is shown. The structuring web server can divide the users into different populations. This division can be explicit, for example by allowing the users to enter information about themselves, or implicit, by inferring the user's most appropriate population segment from his usage patterns of a website. For example, if a user accesses many pages relating to issue X, the structuring web server determines that the user is interested in X.

The structuring web server creates several lists of interesting links for each page (either in one file, or in multiple files) one for each user population. The client downloads the relevant list and performs, for example, link highlighting. A user's group associations can be stored in a local storage structure such as cookies. A structured web add-on of a browser can request a link list from the structuring web server based on the group associations. A group association can be determined by analyzing a user's activities or from explicit user input.

Link highlights can be customized based on the specific population segment that generated them. Thus, if the user is interested in subjects A and B, and a certain link is considered interesting (since for example, it has high click frequency) for the population segment of users interested in subject A, the link can be highlighted with a color signifying subject A, or an icon can be added containing an illustration relevant to subject A.

In a representative example, the improvement data of the Internet customization system indicates that the relevant link 730 is of interest to the user based on subject A. The improvement data of the Internet customization system also indicates that a second relevant link 910 is of interest to the user based on subject B. After executing the link highlighter, the webpage 710 is displayed in browser 720. The webpage 710 includes irrelevant links 740, relevant link 730, and second relevant link 910. Relevant link 730 is highlighted with highlighting 810 associated with subject A and an icon 820 associated with subject A appears next to the relevant link 730. Additionally, second relevant link 910 is highlighted with highlighting 920 associated with subject B and an icon 930 associated with subject B appears next to the second relevant link 910. Advantageously, the user can now easily identify and determine the subject matter of the relevant link 730 and the second relevant link 910.

Referring again to FIG. 6, the content highlighter 610 highlights content identified by improvement data. If the usage data suggests that it is very likely that a particular portion of the content on a webpage might be of interest to a user, the content highlighter 610 highlights the relevant content portion on the webpage. For example, in a thread consisting of many posts or a list of talkbacks, the most interesting items can be highlighted by changing their color, background or adding icons, as discussed above with regard to the link highlighter 605.

The detection of the interesting content can be based on user behavior or guided by the user. For example, a user can show interest or disinterest in content clicking thumbs up/thumbs down buttons placed next to content, scrolling to the interesting content, or hovering over interesting content with the mouse.

For instance, the content highlighter 610 can insert the HTML code “<font style=”background-color: yellow;“>” and “</font>” around the content to be highlighted in the respective webpage's HTML file. The content highlighter 610 can also add a small icon next to the content or change the background color or image of the content in order to differentiate it from other content. This change can be static, or activated by some user action, such as clicking a “highlight-content” button on a toolbar, or hovering with a mouse cursor over a certain area of the webpage. The content highlighter 610 can also create an animated change. Icons or backgrounds can vary according to the nature of the highlight. A highlight can depend on the reason the content is interesting. A content portion that is likely to interest the user can be colored red. A content portion that might not be of absolute interest to the user, but is still much more interesting to the user than it is for the general population, can be colored yellow.

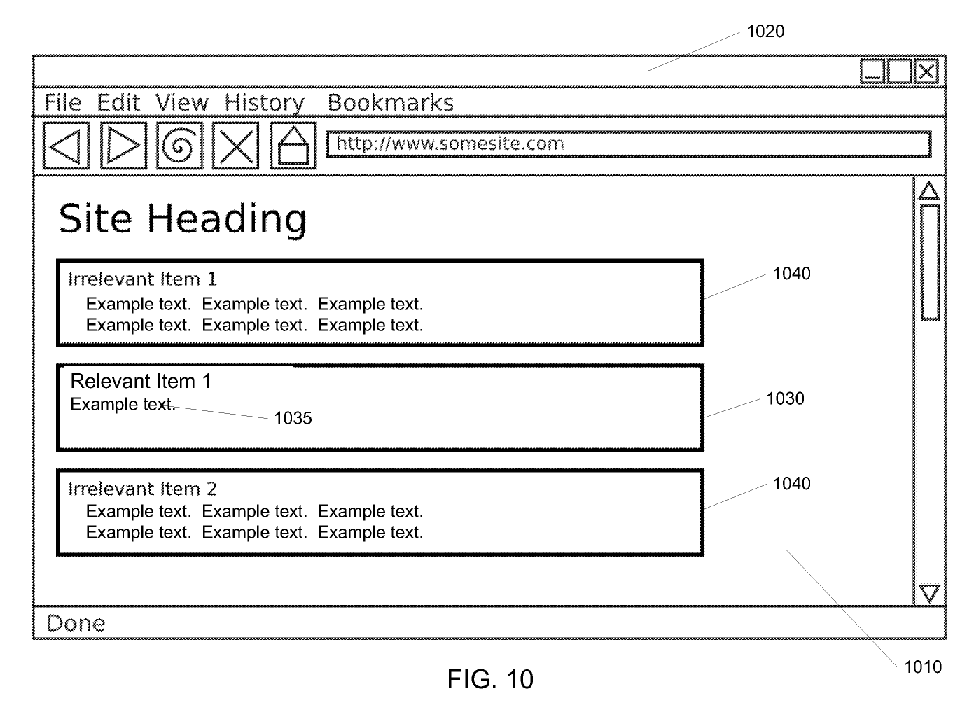

Referring now to FIG. 10, an illustration of an unmodified webpage with content in accordance with a representative embodiment is shown. A webpage 1010 is displayed in browser 1020. The webpage 1010 includes irrelevant content 1040 and relevant content 1030 including relevant text 1035. Relevant content 1030 does not stand-out on the webpage 1010 and, therefore, is difficult for a user to quickly identify the relevant content 1030.

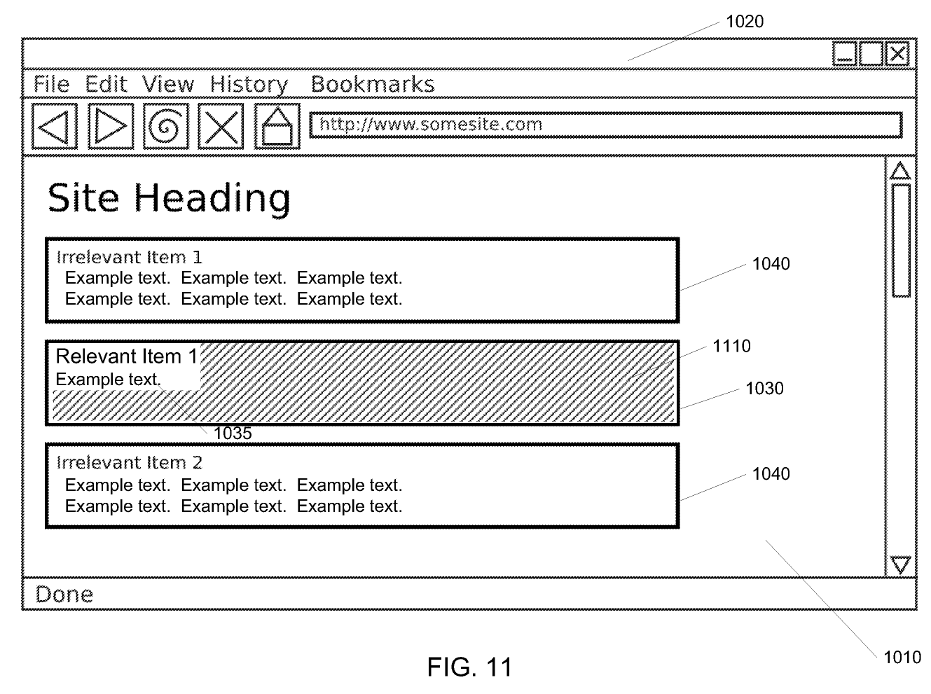

Referring now to FIG. 11, an illustration of the webpage of FIG. 10 with content highlighted in accordance with a representative embodiment is shown. The Internet customization system collects and aggregates the statistics for the viewing frequency of all content. The Internet customization system then determines the interest level of each piece of content. The interest level of each piece of content can be determined for instance by the length of time spent viewing each piece of content. Thus, content with high view times are determined to be of interest to the users. If, for example, upon reaching a page, a certain piece of content has a probability of being viewed greater than a threshold, then the content is considered to be interesting. Other factors, such as keywords in the content, links related to the content, etc. can also be taken into account when determining the interest level of each piece of content.

In a representative example, the usage data of the Internet customization system indicates that relevant content 1030 is of most interest to the user based on other users' with similar profiles content choices. After executing the content highlighter, the webpage 1010 is displayed in browser 1020. The webpage 1010 includes irrelevant content 1040 and relevant content 1030 including relevant text 1035. Now, relevant content 1030 is highlighted with highlighting 1110. Advantageously, the user can now easily identify the relevant content 1030. When the system detects that content is new in the page, it can also highlight it with a special “new content” icon. Also, when the content highlighter is applied to a page containing search results, the most appropriate search results for the user's profile and keywords are highlighted, thus substantially improving the search.

Referring again to FIG. 6, the scroll suggestion generator 615 enables automatic scrolling on a webpage. Some pages are very long and require the user to scroll down to reach the parts relevant to him. The data analyzer can automatically learn the needed scrolling, and generate improvement data that instructs the restructurer to automatically scroll the page. Usage data from the structuring web server can be used to identify content of interest to a user. For example, if the improvement data suggests that it is very likely that a particular portion of the content on a webpage might be of interest to a user, when the user opens a webpage, the scroll suggestion generator 615 scrolls or jumps to the particular portion of the content.

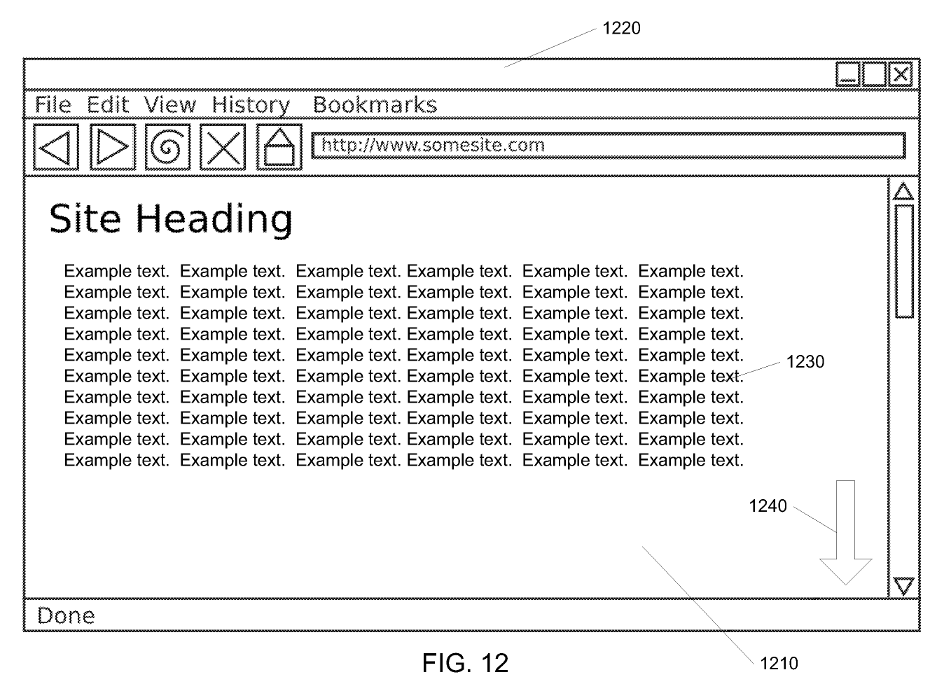

Alternatively, the scroll suggestion generator 615 adds a button that suggests the scroll. Referring now to FIG. 12, an illustration of a webpage with a scroll suggestion in accordance with a representative embodiment is shown. A webpage 1210 is displayed in browser 1220. The webpage 1210 includes content 1230. A scroll suggestion generator places a scroll suggestion 1240. When a user clicks on scroll suggestion 1240, the browser 1220 scrolls or jumps to a relevant portion of the content based on improvement data. Advantageously, the user can now easily reach the relevant content.

Referring again to FIG. 6, the quick navigation bar generator 620 displays a list of relevant links in a quick navigation bar displayed by a browser. Based on usage data the links of a website that are especially valuable for a user can be determined, and thus always made available to him. Valuable links can be, for example, the most frequently used links, links which are very frequent relative to their click distance from the main pages, or several key pages of the site enabling easy access to its most used parts. The quick navigation bar includes a set of these best intra-site links (i.e. bookmarks) which is automatically generated for the user. The quick navigation bar generator 620 ensures that the bookmarks are always live links (i.e. unbroken and up-to-date). The quick navigation bar displays the bookmarks in a convenient, consistent and noticeable fashion throughout the pages of the website.

These bookmarks are gathered and automatically inserted to the site where they are displayed on as bar—the quick navigation bar. The quick navigation bar can be easily and automatically placed at the top of the page, at the bottom, at either side, embedded in a menu or included as a floating element. The quick navigation bar can be encoded into a webpage's HTML code. The quick navigation bar can always be kept visible, or it can be turned on by clicking a button or by hovering over an area on the page. For example, the quick navigation bar can always kept visible at the top of a window of the browser, pushing all of the webpages' content down. In another example, the content is not pushed (the quick navigation bar hides the top of the content), but the quick navigation bar is only visible when the cursor is over some area, or when an icon or a button is clicked. The bookmark links in the quick navigation bar can be intra-site links, a predefined set of sites, or extra-site links.

The bookmarks in the quick navigation bar can be formatted in various ways, for instance, using various coloring or icons. The bookmarks can have uniform coloring in order to not distract the user. This coloring can match the webpage. The bookmarks can be each colored in a unique and persistent color, thus helping the users to spot their preferred links quickly. Giving each bookmark a unique and persistent color can also help a user determine when the contents of the quick navigation bar change (e.g. when new links are added, or old ones removed) since the links can be found quickly by color and location. The bookmarks can have uniform coloring, however, particularly popular links could be colored differently. Likewise, intra-site links can have a different color (or icon) than extra-site links. As in the link highlighter 605, discussed above, if a link in the quick navigation bar is added based on a particular population segment, an icon signaling this fact can be added to the link.

In a representative example, as with the link highlighter 605, a script file can be referenced by the webpages of the site (by any one of the above mentioned methods) sending usage statistics. Usage statistics and links can also be segmented according to the user's population, as described above. Based on these statistics the Internet customization system manufactures a list of the most relevant links, for the particular user, in the entire site. The client downloads it and automatically injects the quick navigation bar to the page by modifying the DOM by inserting appropriate HTML elements and filling them with the relevant content.

The insertion of the quick navigation bar in the page, pushing all the contents down, can be done by enlarging the top-margin of the document's body, by enlarging the width of the top border of the document's body, by changing the position of the document's body or by encapsulating all of the contents of the page by an element such as a HTML tag “div” and placing that “div” in the correct place. Insertion of the quick navigation bar in the page, without pushing the contents down, can be done by placing the quick navigation bar in an element such as a “div” and giving it an “absolute-positioning” or a “static-positioning.”

In addition, the webpages on a web server can already contain placeholders for a quick navigation bar. In this case, the client does not need to inject new elements to the DOM but merely fill in the contents of existing ones. For example, in a site with built-in navigation menus, one of these menus entries can be called “quick navigation bar” and its entries will be dynamically and automatically filled by the quick navigation bar generator 620.

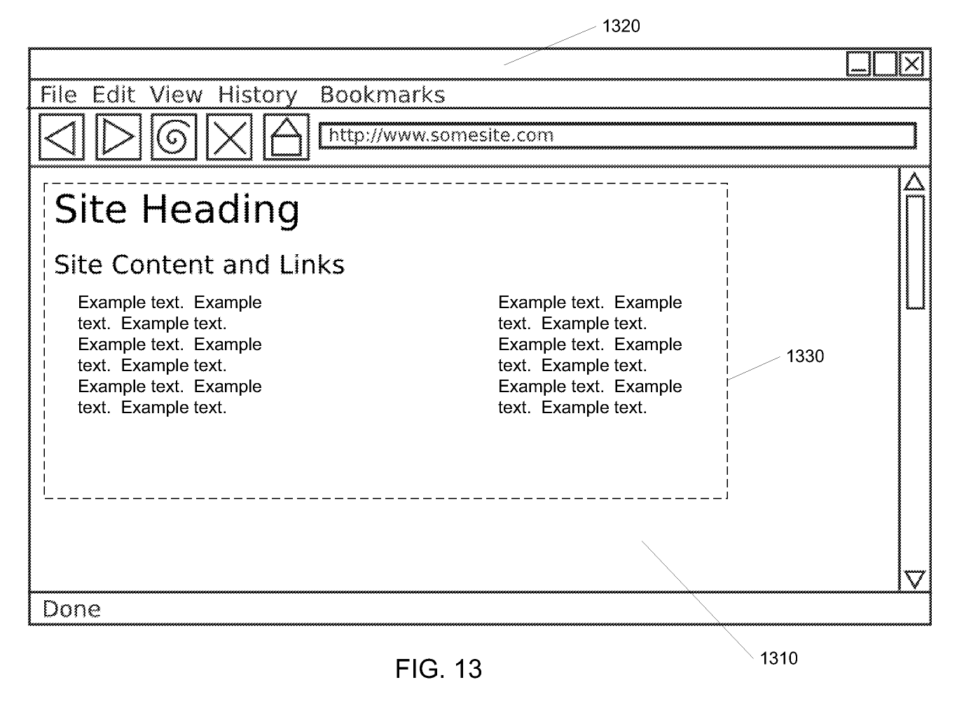

Referring now to FIG. 13, an illustration of a second unmodified webpage in accordance with a representative embodiment is shown. A webpage 1310 is displayed in browser 1320. The webpage 1310 includes content 1330.

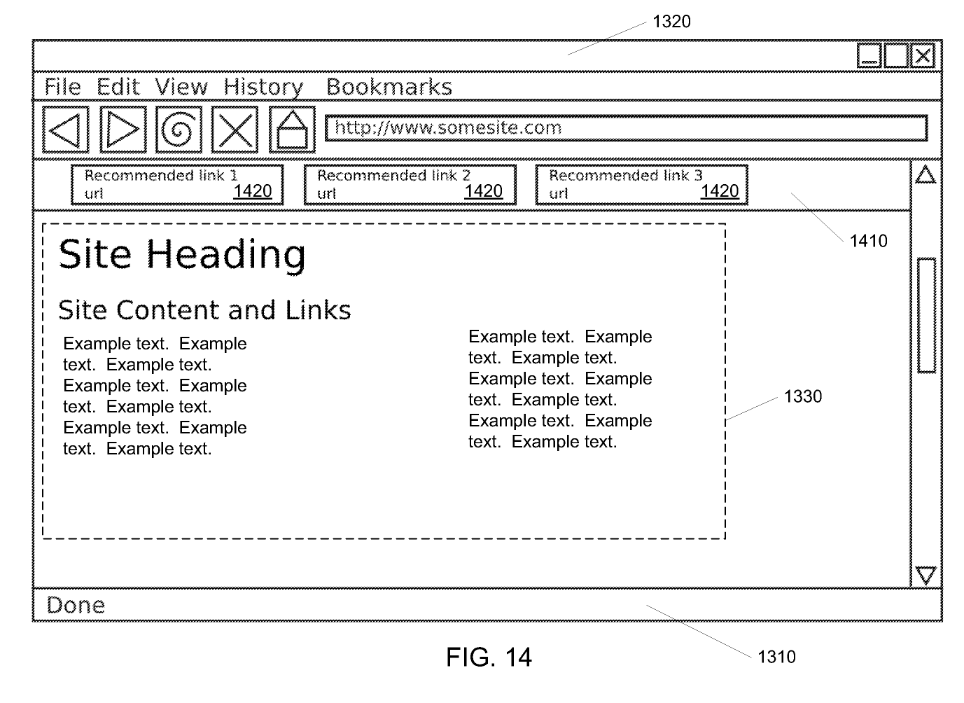

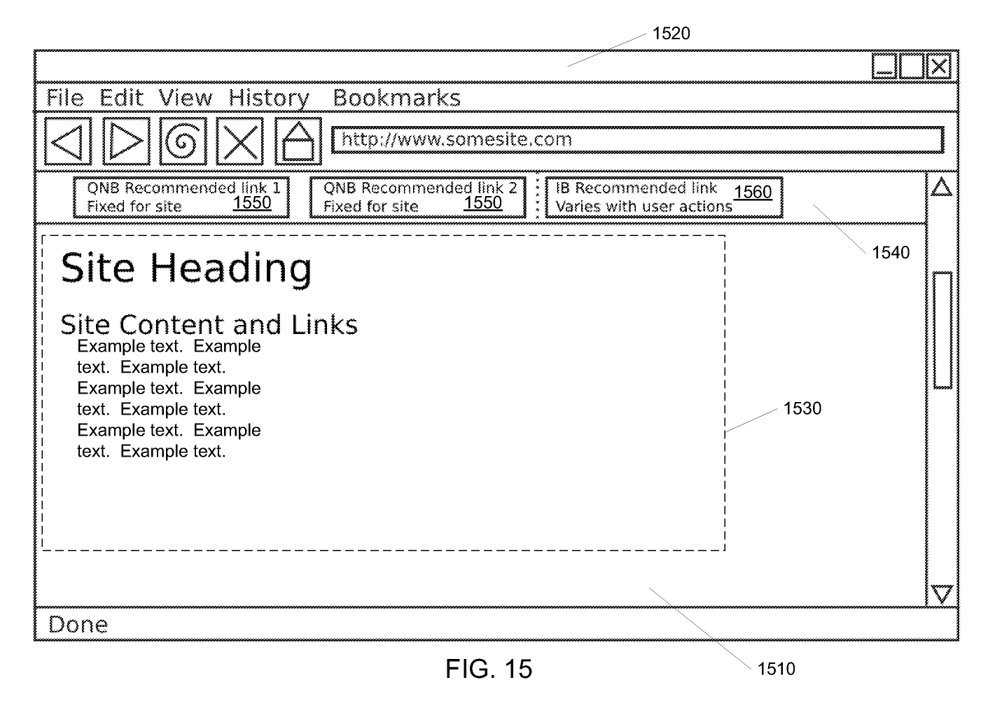

Referring now to FIG. 14, an illustration of the webpage of FIG. 13 with a quick navigation bar in accordance with a representative embodiment is shown. The Internet customization system collects and aggregates the statistics for bookmarks as described above. The webpage 1310 is displayed in browser 1320. The webpage 1310 includes content 1330. A quick navigation bar generator takes the bookmarks and generates a quick navigation bar 1410. The quick navigation bar 1410 includes bookmarks 1420. The quick navigation bar 1410 is displayed at the top of the webpage 1310, the content 1330 of which is pushed down. Advantageously, a user can quickly find relevant bookmarks (i.e. links).

Referring again to FIG. 6, the immediate bar generator 625 displays links that are currently relevant. The immediate bar generator 625 is similar to the quick navigation bar generator 620, except that in the quick navigation bar generator 620, the links generally have a more static nature and are not frequently changed so that users will get accustomed to the physical location of the bookmarks(links). Thus, the links related to the quick navigation bar generator 620 generally remain constant throughout the surfing of the various pages of a website.

The immediate bar generator 625, on the other hand, can contain the most relevant links (as defined above) given the more current state of the surfing, such as the current webpage of the website, the recent browsing history, recent user interaction, etc. For example, if a user is surfing a certain webpage of the website and he got there through a certain sequence of actions or search terms, the immediate bar generator 625 can show the most relevant links given this current information. In contrast, the quick navigation bar generator 620 can show the most relevant links for the entire site, regardless of this current information. Alternatively, a single bar can mix the results from the immediate bar generator 625 and the quick navigation bar generator 620. Referring now to FIG. 15, an illustration of a webpage with a mixed quick navigation bar and immediate bar in accordance with a representative embodiment is shown. The Internet customization system collects and aggregates the statistics for bookmarks and the current state of surfing as described above. A webpage 1510 is displayed in browser 1520. The webpage 1510 includes content 1530. A quick navigation bar generator takes the bookmarks and generates a portion of mixed quick navigation bar and immediate bar 1540. The quick navigation bar portion of mixed quick navigation bar and immediate bar 1540 includes quick navigation bookmarks 1550. The immediate bar portion of mixed quick navigation bar and immediate bar 1540 includes immediate links 1560. The mixed quick navigation bar and immediate bar 1540 is displayed at the top of the webpage 1510, the content 1530 of which is pushed down. Advantageously, a user can quickly find relevant quick navigation bookmarks and immediate links.

Referring again to FIG. 6, the fast forward generator 630 enables a user to jump irrelevant links. Some links are rarely used for their own merit but rather as a part of a link chain.

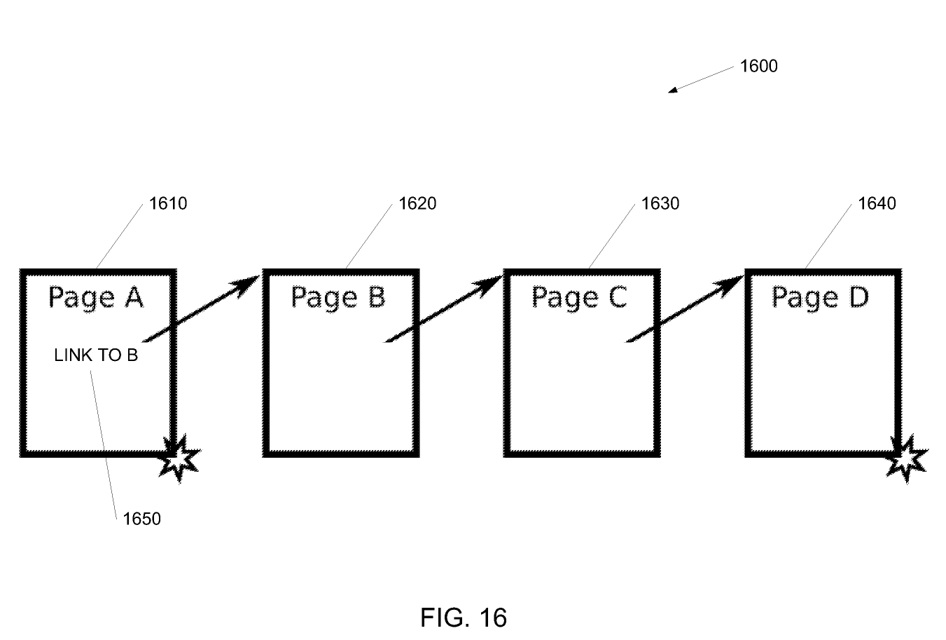

Referring now to FIG. 16, an illustration of a first link chain 1600 in accordance with a representative embodiment is shown. In first link chain 1600, page A 1610 and page D 1640 are the only pages of interest. However, a direct link from page A 1610 to page D 1640 does not exist. Instead, there is a link from page A 1610 to page B 1620, a link from page B 1620 to page C 1630, and a link from page C 1630 to page D 1640. If such a situation occurs, as is manifested by the usage data, fast forward generator 630 automatically inserts a fast forward button next to a link to page B 1650 on page A 1610. The fast forward button links directly to page D 1640, enabling an easy and convenient way for the user to reach page D 1640 with only one click.

When clicking the fast forward button a menu can open presenting to the user the title of page D 1640, the text of the link on page C 1630 leading to page D 1640, a URL of page D 1640, or any subset of the above. Clicking on a menu item will take the user directly to page D 1640. Alternatively, instead of clicking the fast forward button, the menu can be opened by hovering over the fast forward button with a cursor. Alternatively, there is no menu and a click on the fast forward button will take the user directly to page D 1640. The fast forward button can be used to jump to a page in a link chain of any length.

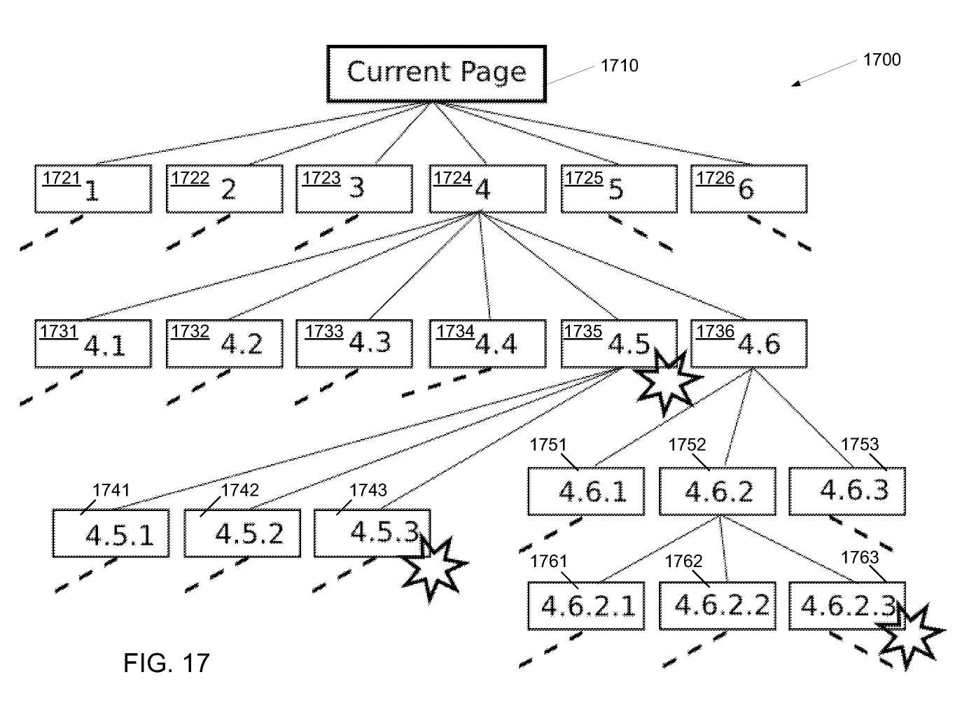

Referring now to FIG. 17, an illustration of a second link tree 1700 in accordance with a representative embodiment is shown. A website 1700 includes a current page 1710, first level pages 1721-1726 (corresponding to page numbers 1-6), second level pages 1731-1736 (corresponding to page numbers 4.1-4.6), third level pages 1741-1743 (corresponding to page numbers 4.5.1-4.5.3) and 1751-1753 (corresponding to page numbers 4.6.1-4.6.3), and fourth level pages 1761-1763 (corresponding to page numbers 4.6.2.1-4.6.2.3). A user is on the current page 1710 which contains links to the first level pages 1721-1726. The main pages of interest to the user in the site, denoted by a star icon, are pages 1735, 1743, and 1763. A fast forward generator places a fast forward button in the current page 1710.

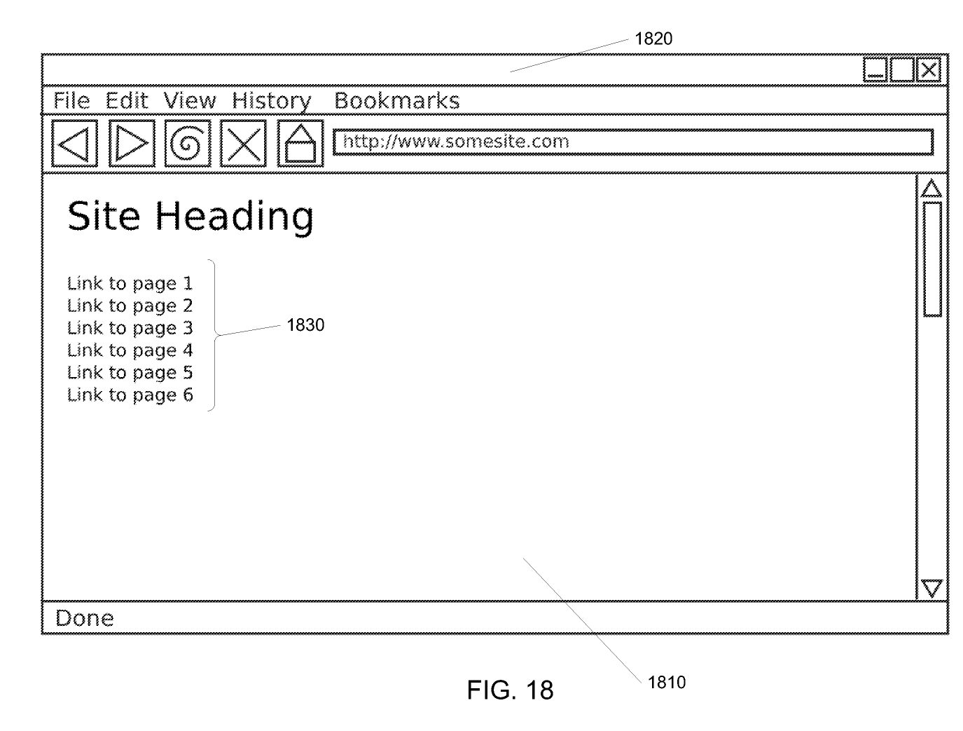

Referring now to FIG. 18, an illustration of an unmodified webpage 1810 with links in accordance with a representative embodiment is shown. The webpage 1810 is displayed in browser 1820. The webpage 1810 includes first level inks 1830 which correspond to first level pages.

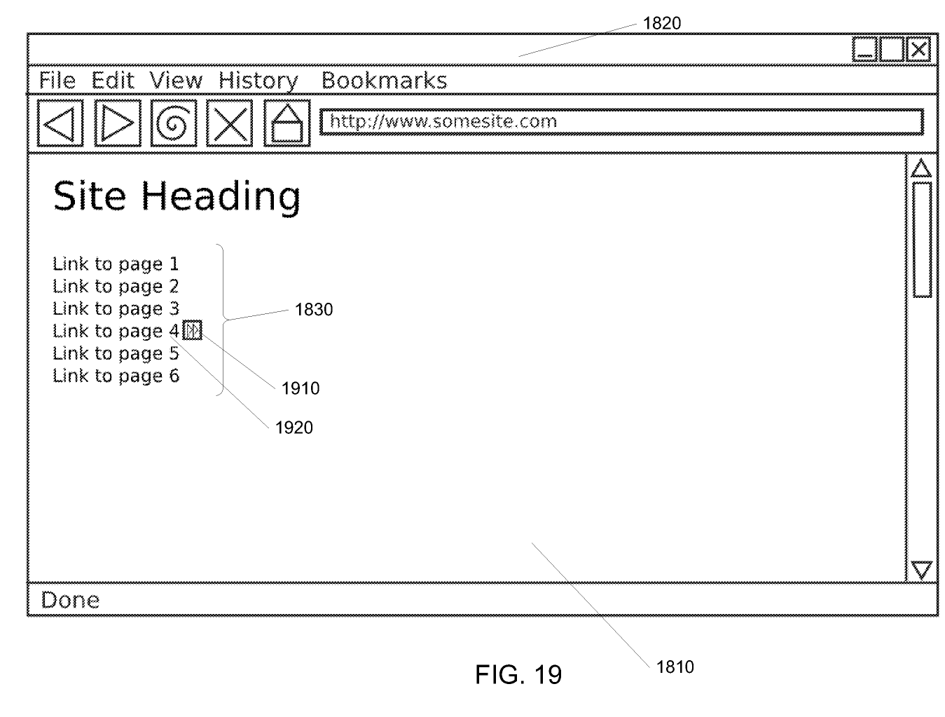

Referring now to FIG. 19, an illustration of the webpage of FIG. 18 with a fast forward button 1910 in accordance with a representative embodiment is shown. The webpage 1810 is displayed in browser 1820. The webpage 1810 includes first level links 1830 which correspond to first level pages. The fast forward generator has placed a fast forward button 1910 next to a relevant link 1920. Clicking on the relevant link 1920 can take the user to a page on the first level, in this case, the page associated with page 1724 of FIG. 17. However, clicking on the fast forward button 1910 will take the user to a page on a higher level, in this case, the page associated with page 1735 of FIG. 17. Alternatively, more than one fast forward button can be displayed, each linking to a different page, including pages at other websites.

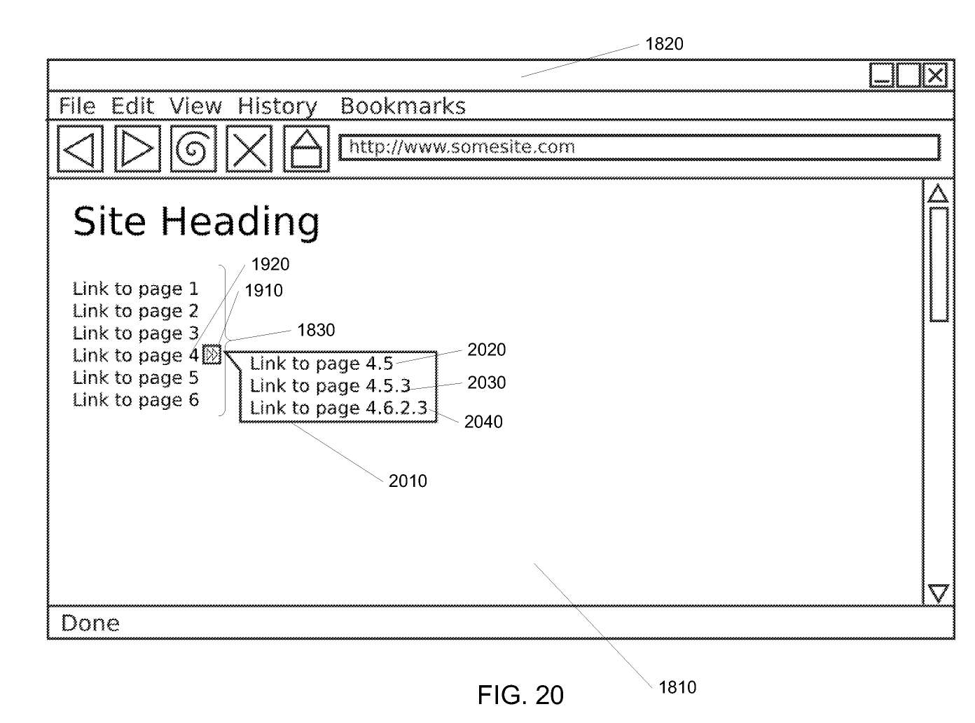

Referring now to FIG. 20, an illustration of the webpage of FIG. 19 with a fast forward menu 2010 in accordance with a representative embodiment is shown. The webpage 1810 is displayed in browser 1820. The webpage 1810 includes first level inks 1830 which correspond to first level pages. The fast forward generator has placed a fast forward button 1910 next to a relevant link 1920. Clicking on the fast forward button 1910 can open the fast forward menu 2010. The fast forward menu 2010 can include a first jump link 2020, a second jump link 2030, and a third jump link 2040. In this case, the first jump link 2020 is associated with page 1735 of FIG. 17. The second jump link 2030 is associated with page 1743 of FIG. 17. The second jump link 2040 is associated with page 1763 of FIG. 17. Thus, a user can quickly jump to any of the pages represented by the first jump link 2020, the second jump link 2030, and the third jump link 2040 without navigating through the links on a website.

When calculating what pages should be included in the fast forward menu 2010, the data analyzer takes into account different factors such as the overall interest level of the link, the distance to the link (e.g. a farther link with a slightly higher interest level may be more important than a slightly less interesting link that is accessible with only two clicks) as well as other factors.

Referring again to FIG. 6, the automatic form completer 635 can automatically fill out web forms of a webpage for a user. The Internet customization system maintains usage statistics related to a user's selections/answers for visited forms. The automatic form completer 635 can determine if certain form fields are usually filled with the same answers. For example, in a drop down list, one choice may be selected with very high probability. A list of recommended default values is then created by the data analyzer and served to a restructurer, which uses it to automatically fill the form with the correct default values. The data analyzer can also divide users into population segments as discussed above correlating a user's answers with his group—as then the user's choices have lower entropy and the default values are correct with high probability.

The personalized page generator 640 can create a personalized page for a user, which can contain all or some of the improvements. For example, the personalized page could contain a quick navigation bar, relevant links, and clippings of relevant content. Instead of sending improvement data and having a client modify the visited pages, the user visits a special page containing the improvements pre-rendered. Thus unmodified webpages do not need to be automatically modified by the client or the structuring web server. The client can still send usage statistics to the structuring web server, however, the client does not necessarily need improvement data or modified pages from the structuring web server. Additionally, the personalized page can be used together with modified webpages.

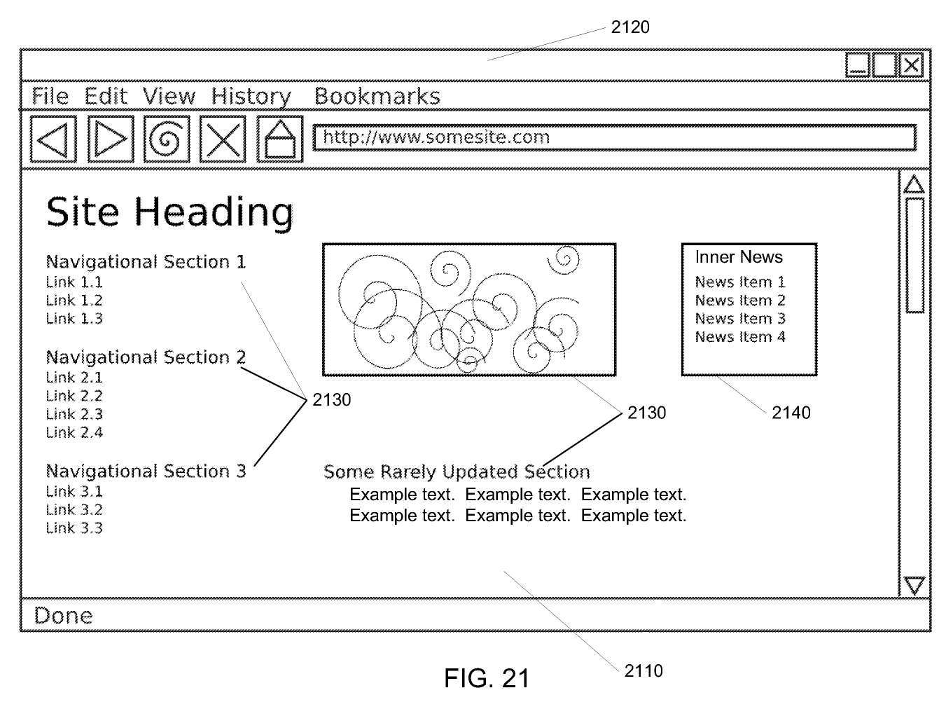

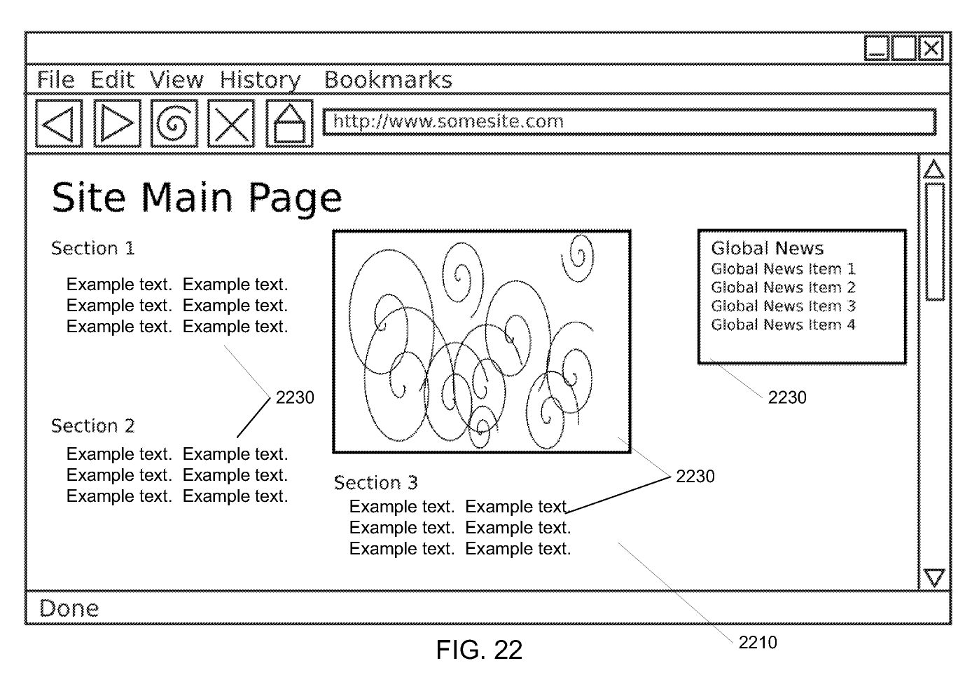

The minified page generator 645 displays a portion of another webpage. Often, a webpage of a website has a small area containing real content while most of its area is used for navigation or graphic design. For example, some webpages contain a list of news items, which constitute the real content, and many other less relevant elements. Referring to FIG. 21, an illustration of an unmodified webpage 2110 with items in accordance with a representative embodiment is shown. The webpage 2110 is displayed in browser 2120. The webpage 2110 includes irrelevant items 2130 and relevant item 2140. Relevant item 2140 relates to another relevant webpage. Referring to FIG. 22, an illustration of a relevant webpage 2210 in accordance with a representative embodiment is shown. The webpage 2210 includes content 2230.

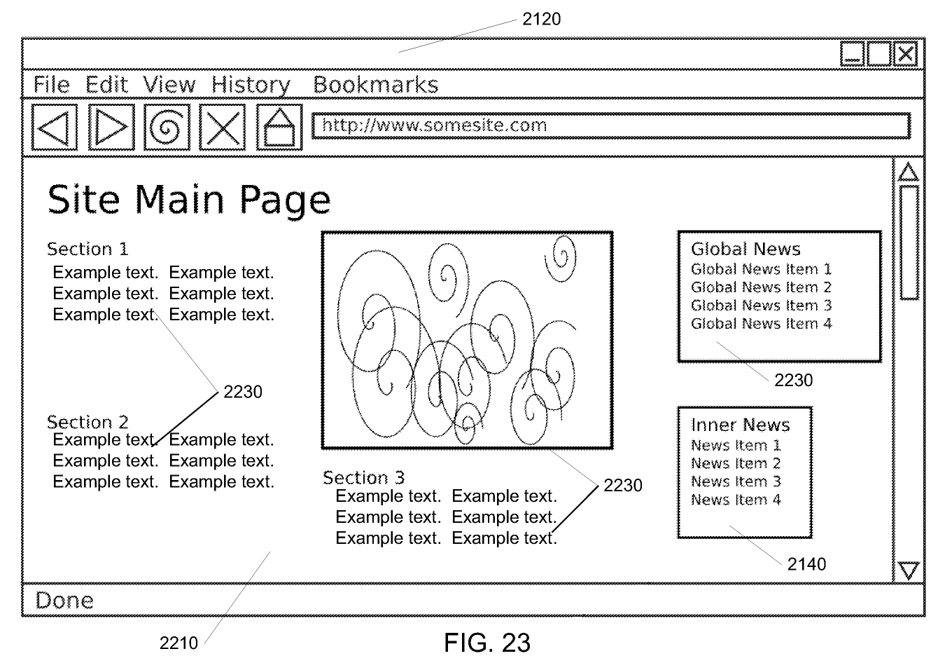

Referring to FIG. 23, an illustration of the webpage of FIG. 22 with a minified page in accordance with a representative embodiment is shown. The minified page generator can insert a relevant piece of a page, such as the news part of a page into another page, such as the main page of the site or a personal page as described above. For example, the minified page generator clips relevant item 2140 (of FIG. 21). The minified page generator then displays the relevant item 2140 (of FIG. 21) in webpage 2210, as illustrated in FIG. 23.

A minified version of a page can be created manually by the web server webmaster. A minified version of a page can also include the entirety of a relevant page (for example, using an HTML tag “iframe”); however, styling techniques can be used to only show the relevant portions.

The detection of the relevant part of a page can also be done automatically, for example by analyzing user behavior on a page, by letting the users indicate the relevant part themselves, and by aggregating data.

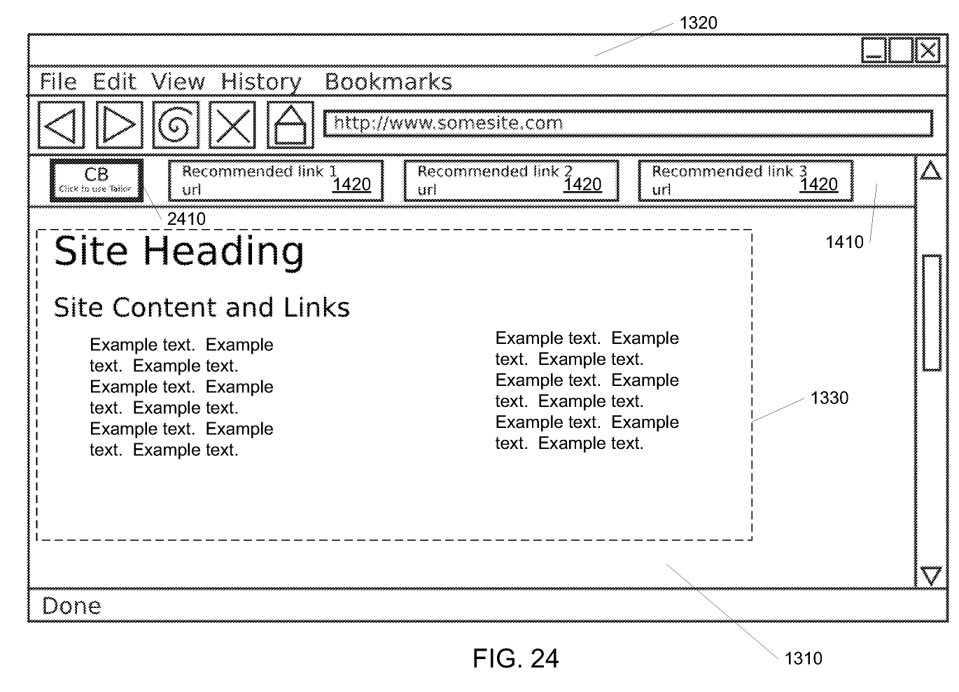

Referring again to FIG. 6, the control button generator 650 enables turning on and off the Internet customization system and/or its individual features. Referring now to FIG. 24, an illustration of the webpage of FIG. 14 with a control button 2410 in accordance with a representative embodiment is shown. The webpage 1310 is displayed in browser 1320. The webpage 1310 includes content 1330. A quick navigation bar generator takes the bookmarks and generates the quick navigation bar 1410. The quick navigation bar 1410 includes bookmarks 1420 and a control button 2410. The quick navigation bar 1410 is displayed at the top of the webpage 1310, the content 1330 of which is pushed down.

Clicking the control button 2410 opens a menu with various options such as “disable/enable Internet customization system”, “disable/enable link highlighter”, “disable/enable quick navigation bar” and “disable/enable fast forward”. In case of a client-side script, any one of the features can be disabled using DOM or style manipulations. In case of server-side improvements injection, a webpage can be regenerated on the structuring web server instead of disabling the improvements on the client. The control button menu can also present other options, such as entering or modifying information about the user's profile. The information can then used by the system to determine, for example, the user's population segment, which in turn enables segmented statistics and providing the user with improvements which are tailored to him (as described above).

Referring again to FIG. 6, the broken link module 655 ensures that the links presented to a user (e.g. in the quick navigation bar or in the fast forward button) are always updated and never broken. For example, the broken link module 655 can prevent links which haven't been accessed at all or which have not been successfully accessed (depending on the nature of the statistics data available) for a set period of time to be present in the improvement data. After the occurrence of a predefined number of unsuccessful accesses to a link, the link is automatically added to a list of broken links (similar to the list of interesting links used for the link highlighter above). The data analyzer then makes sure not to include the link in the improvement data it generates, thereby ensuring that the link will not appear in the quick navigation bar or fast forward menu, for example. In addition, a client downloads this list and can then disable the relevant links, or add an icon depicting the fact that the links might be broken. Upon the occurrence of a predefined number of successful accesses to the page, the link and associated links can be automatically removed from the broken links list. A report is sent to a web server's webmaster.

In addition to detecting and signaling broken links, the system can also fix them. The Internet customization system can learn a correct replacement link for a broken link, for example, by analyzing the user's behavior. The broken link module 655 can present the user with the ability to reach the replacement page automatically (e.g. in a manner very similar to the fast forward). Alternatively, a web server's webmaster can indicate the replacement page manually.

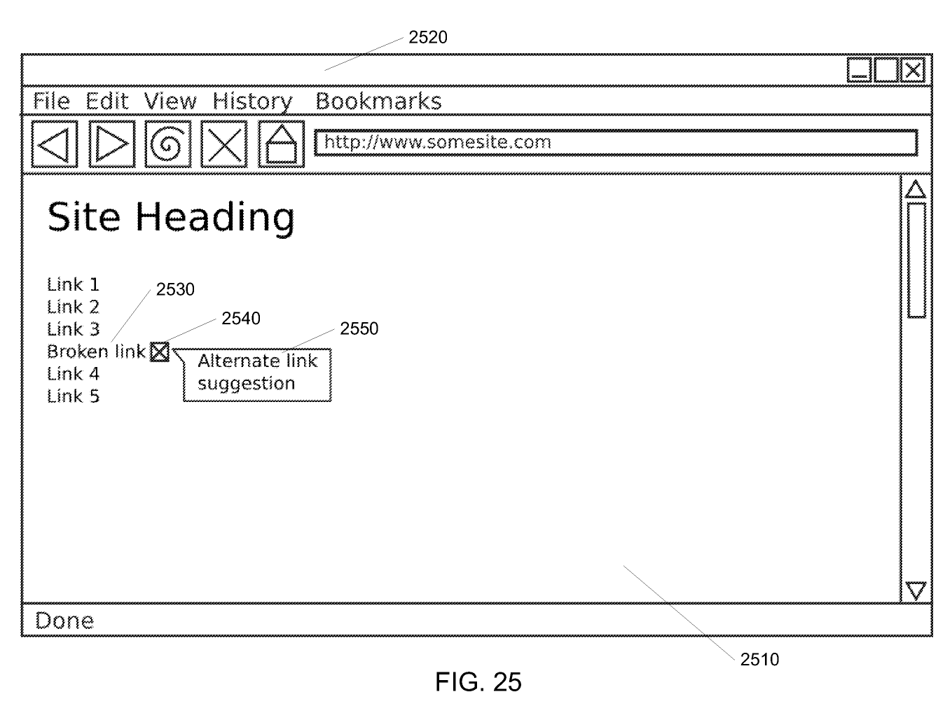

Referring to FIG. 25, an illustration of a webpage 2510 with link fix in accordance with a representative embodiment is shown. The webpage 2510 is displayed in browser 2520. The webpage 2510 includes broken link 2530. The broken link module places a broken link icon 2540 next to the broken link 2530. When the user clicks or hovers over the broken link icon 2540 a link fix suggestion menu 2550 appears. Advantageously, the user can avoid broken links.

The Internet customization system can include a self-enhancement feature allowing all the improvements discussed above to be continuously enhanced. For example, recommendations (such as a relevant link suggestion) can be changed based on updated usage statistics. New recommendation can replace those recommendations determined to be unhelpful. For example, if the system adds a fast forward menu with three links, one of which was never used by the users with a specific profile, the system will learn this usage pattern and remove this link from the fast forward menu of users with this same profile in the future.

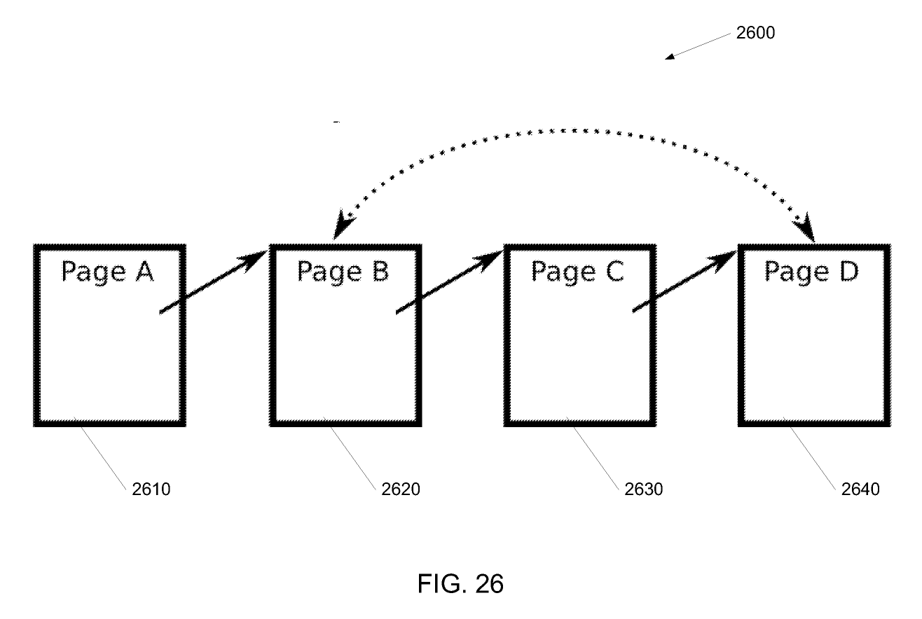

Referring to FIG. 26, an illustration of a third link chain 2600 in accordance with a representative embodiment is shown. The third link chain 2600 includes page A 2610, page B 2620, page C 2630, and page D 2640. The Internet customization system, for example, the structuring web server, might determine that a more relevant way to structure the third link chain 2600 is to provide a direct link from page B 2620 to page D 2640. The structuring web server can notify the webmaster of the web server of the suggested change or produce improvement data on the structuring web server to re-link the third link chain 2600 so that page B 2620 is linked to page D 2640. Thus, the web site can be improved after the web design has been implemented.

The Internet customization system enables separation of the decisions regarding the structure of the site from those regarding the design of the site itself by modifying the pages the user sees. The user's browser no longer renders the HTML page it downloaded from the server directly, but rather a modified version with improved and more appropriate design choices for the specific user. The system thus enables delaying the decisions of which web design to use until such time as all the relevant information is available. The Internet customization system then automatically actuates the most appropriate/relevant structural choice at runtime. In addition, since the structural decisions of a website are made after pages were written, malfunctions such as broken links or out-of-date links can be completely resolved, since the structure present in the HTML itself becomes only a guideline to the final structure of the site.

The Internet customization system and method can operate with minimal or no changes to existing website pages. Hence, the Internet customization system and method can be applied to large and existing websites. In one representative embodiment, an existing web server does not need to be modified in order to implement the system. The user can install a browser plug-in that enables the functionality of the Internet customization system. Thus the Internet customization system and method can be “added” to all existing websites immediately.

Advantageously, the Internet customization system enables a website builder to postpone the time of the conception of the structure of the website to a much later time, when the website is populated with content and when the website is actually being visited. At this later time, the decisions about the optimal structure of the website can be made in a much more educated fashion. Moreover, the Internet customization system makes these decisions automatically and continuously, thus reducing the cost of the site building as well as the cost of its ongoing maintenance. Finally, since the Internet customization system can delay the web site structure decisions until the site visit time, the Internet customization system can make different choices based on a visiting surfer's profile, thus presenting each surfer with a tailored site structure.

The foregoing description of the exemplary embodiments have been presented for purposes of illustration and of description. It is not intended to be exhaustive or to limit the invention to the precise form disclosed, and modifications and variations are possible in light of the above teachings or may be acquired from practice of the invention. For example, the described representative embodiments focused on HTML base webpages and websites. The present invention, however, is not limited to HTML files. Those skilled in the art will recognize that the device and methods of the present invention may be practiced using other network serving languages and means. Additionally, the web server can be any device that stores webpages or that links files. Whenever an action is said to be automatic, it can also be done manually. The embodiments were chosen and described in order to explain the principles of the invention and as practical applications of the invention to enable one skilled in the art to utilize the invention in various embodiments and with various modifications as suited to the particular use contemplated. It is intended that the scope of the invention be defined by the claims appended hereto and their equivalents.

What is claimed is:

1. An apparatus for structuring web content, comprising:
a structuring web server including:
a data collection server configured to collect usage data associated with at least one user;
a data analyzer configured to generate improvement data based on the usage data; and
a structured content server configured to send the improvement data to a browser associated with the at least one user,
wherein the browser uses the improvement data to alter a webpage displayed to the at least one user.

2. The apparatus of claim 1, wherein the data analyzer is further configured to generate the improvement data based on an explicit profile of the at least one user.

3. The apparatus of claim 1, wherein the browser is associated with a link highlighter configured to use the improvement data to modify links in the webpage.

4. The apparatus of claim 1, wherein the browser is associated with a content highlighter configured to use the improvement data to modify content in the webpage.

5. The apparatus of claim 1, wherein the browser is associated with a scroll suggestion generator configured use the improvement data to jump to at least one position in the webpage.

6. The apparatus of claim 1, wherein the browser is associated with a bar generator configured to use the improvement data to display at least one relevant link in a defined portion of the webpage.

7. The apparatus of claim 1, wherein the browser is associated with a fast forward generator configured to use the improvement data to create a link that jumps to at least one other webpage of a website, the at least one other webpage being at least two links away from the website.

8. The apparatus of claim 1, wherein the browser is associated with a personalized page generator configured to use the improvement data to create a new webpage, wherein the new webpage includes at least one link to a relevant webpage.

9. The apparatus of claim 1, wherein the browser is associated with a minified page generator configured to use the improvement data to insert at least a portion of a relevant webpage into the webpage.

10. A system for structuring web content, comprising:
a web server configured to serve webpages;
a structuring web server configured to collect usage data associated with the webpages, and generate improvement data based on the usage data; and
a client configured to display webpages altered based on the improvement data and an explicit profile of a user.

11. The system of claim 10, wherein the client is configured to build the explicit profile by querying the user based on the improvement data.

12. The system of claim 10, wherein the structuring web server comprises an identification server, and wherein the client comprises an identification module, wherein the identification module enables the identification server to associate usage data with the explicit profile of the user.

13. The system of claim 10, wherein the structuring web server comprises a data analyzer configured to determine at least one of relevant links or content based on a probability of a webpage visit derived from the usage data.

14. The system of claim 10, wherein the usage data comprise at least one of website visits, time spent viewing a website, portion of website viewed, frequently visited sites, keywords, form data entered, and personal information.

15. A method for structuring web content, comprising:
collecting, at a computing device, data from at least one client;
building an explicit profile of a user;
analyzing the data from the at least one client;
generating improvement data based on the analysis; and
generating information for modifying a webpage based on the improvement data and the explicit profile.

16. The method of claim 15, wherein the computing device comprises a client.

17. The method of claim 15, wherein said modifying the webpage comprises running a restructurer associated with a browser.

18. The method of claim 15, wherein said building an explicit profile comprises querying the user.

19. The method of claim 18, wherein the query is based on the improvement data.

20. The method of claim 15, wherein the improvement data is based on the probability that a plurality of users associated with a particular profile will visit a particular webpage.

21. The method of claim 15, wherein said modifying the webpage comprises at least one of deleting, adding, and replacing at least a portion of a hypertext markup language file.
